(19) United States
(12) Patent Application Publication
(10) Pub. No.: US 2017/0247242 A1
(43) Pub. Date: Aug. 31, 2017

(54) FLUID DISPENSING SYSTEMS

(71) Applicant: FUEL TRANSFER TECHNOLOGIES INC., Moncton (CA)

(72) Inventor: Mark Bonner, Frenchtown, NJ (US)

(21) Appl. No.: 15/507,715

(22) PCT Filed: Aug. 28, 2015
(86) PCT No.: PCT/CA2015/050831

§ 371 Date: Feb. 28, 2017

Related U.S. Application Data
(60) Provisional application No. 62/043,339, filed on Aug. 28, 2014.

(51) Int. Cl. B67D 7/48; B67D 7/56; B67D 7/04; B67D 7/54

(52) U.S. Cl. CPC B67D 7/48; B67D 7/54; B67D 7/565; B67D 7/0484; B67D 7/04; B67D 7/344

(57) ABSTRACT

A fluid dispensing system. The fluid dispensing system includes a portable source container, a fluid dispensing nozzle, a pump system, a fluid conduit, and a power connector. The pump system includes at least one pumping portion for pumping fluid through a first fluid passage, an electric motor for powering the first pumping portion and a power receptacle for receiving power to the electric motor. The pump system is coupled the source container or the fluid dispensing nozzle. The power connector includes at least one retaining clip biased to a retaining configuration, the first retaining clip in the retaining configuration being configured to enable the power connector to be retained in the power receptacle.

### CROSS-REFERENCE TO RELATED APPLICATIONS

This disclosure claims priority from U.S. provisional patent application No. 62/043,339, filed Aug. 28, 2014, the entirety of which is hereby incorporated by reference.

### FIELD

The present disclosure relates generally to systems, apparatuses and methods for dispensing fluids such as fuel (e.g., petroleum-based fuels) and other liquids. In particular, the present disclosure relates to powered systems and apparatuses for dispensing fluids.

### BACKGROUND

Portable fluid dispensing systems (e.g., manually portable fuel containers and small-sized fuel pumps) tend to be manually powered and relatively simple in construction. Most are typically basic in construction, with the pump as close to the liquid source as possible or even submerged in the source liquid. There is typically a length of delivery hose to take advantage of a siphoning effect. Such systems are typically designed for simplicity rather than efficiency, and typically are poor at pumping.

Such systems may also be prone to user error, which may result in unintentional spillage, overfilling or over-pressurization, for example. It may be desirable to provide features to assist in dispensing of liquid from such systems, to reduce user fatigue, to help reduce overflow and/or to reduce vapor loss.

### SUMMARY

In some examples, the present disclosure provides a fluid dispensing system. The fluid dispensing system includes: a portable source container having at least a container fluid outlet; a fluid dispensing nozzle comprising: a fluid delivery passage for delivering fluid out from a fluid delivery outlet; a pump system comprising: a first pumping portion for pumping fluid through a first fluid passage, the first fluid passage having a first fluid inlet and a first fluid outlet; an electric motor for powering the first pumping portion to pump fluid through the first fluid passage; a power receptacle for receiving power to the electric motor; a fluid conduit for fluid communication from the container interior to the nozzle; wherein the pump system is coupled to one of the source container or the fluid dispensing nozzle; and a power connector comprising: a connector body for insertion into the power receptacle; a first lead and a second lead housed in the connector body, and in electrical connection with a power source; a first terminal and a second terminal accessible from an exterior of the connector body for providing power to the electric motor; and a first retaining clip having a depressed configuration and a retaining configuration, the first retaining clip in the retaining configuration being configured to enable the power connector to be retained in the power receptacle; wherein the first retaining clip is biased to the retaining configuration.

In some examples, the present disclosure provides a fluid return apparatus. The fluid return apparatus includes: a fluid delivery passage for delivering fluid out a fluid delivery outlet; a fluid recovery passage for recovering fluid in from a fluid recovery inlet; a through-passage permitting fluid communication between the fluid delivery passage and the fluid recovery passage; and a valve for controlling flow of fluid between the fluid delivery passage and the fluid recovery passage, the valve having: a first configuration in which fluid communication between the fluid delivery passage and the fluid recovery passage via the through-passage is inhibited; and a second configuration in which fluid communication between the fluid delivery passage and the fluid recovery passage is permitted via the through-passage.

In some examples, the present disclosure provides a valve for controlling flow of fluid. The valve includes: a fluid delivery passage for delivery fluid out of a fluid delivery outlet; a fluid recovery passage for recovering fluid in from a fluid recovery inlet; a first valve portion configured to control fluid flow through the fluid delivery passage, the first valve portion being biased towards a first closed configuration in which fluid delivery out of the fluid delivery outlet is inhibited; a second valve portion configured to control fluid flow through the fluid recovery passage, the second valve portion being biased towards a second closed configuration in which fluid recovery into the fluid recovery inlet is inhibited; the first valve portion defining a first area, the first area being subjected to a force due to fluid pressures from any fluid in the fluid delivery passage, when the first valve portion is in the first closed configuration; wherein the first valve portion is configured to be unseated from the first closed configuration by the force due to fluid pressures exerted on the first area; and wherein unseating of the first valve portion away from the first closed configuration results in unseating of the second valve portion away from the second closed configuration.

In some examples, the present disclosure provides a pump. The pump includes: a pumping portion for pumping fluid through a first fluid passage, the first fluid passage having a first fluid inlet and a first fluid outlet; and a second fluid passage having a second fluid inlet and a second fluid outlet, fluid in the second fluid passage not being pumped by the pumping portion.

In some examples, the present disclosure provides a power connector. The power connector includes: a connector body; a first lead and a second lead housed in the connector body, and in electrical connection with a power source; a first terminal and a second terminal accessible from an exterior of the connector body; and a first retaining clip having a depressed configuration and a retaining configuration; wherein the first retaining clip is biased to the retaining configuration, the first retaining clip, in the retaining configuration, causing at least one of the first or second terminal to come into electrical connection with the respective first or second lead; and when the first retaining clip is in the depressed configuration, at least one of the first or second terminal is prevented from being in electrical contact with the respective first or second lead.

In some examples, the present disclosure provides a pump system. The pump system includes: a pumping portion for pumping fluid through a first fluid passage, the first fluid passage having a first fluid inlet and a first fluid outlet; a second fluid passage having a second fluid inlet and a second fluid outlet, fluid in the second fluid passage not being pumped by the pumping portion; an electric motor for powering the pumping portion to pump fluid through the first fluid passage; a power receptacle for receiving power to the electric motor; a valve configured for controlling flow of fluid in the first fluid passage, the valve being biased towards a closed configuration in which fluid flow in the first fluid passage is inhibited; the valve defining a first area, the first area being subjected to a force due to fluid pressures from any fluid in the first fluid passage, when the valve is in the first closed configuration; wherein the valve is configured to be unseated from the first closed configuration by the force due to fluid pressures exerted on the first area; and the valve defining a second area larger than the first area, the second area being subjected to a force due to fluid pressures in the first fluid passage when the valve has been unseated from the first closed configuration; wherein the valve is configured to be maintained away from the first closed configuration by the force due to fluid pressure exerted on the second area, the fluid pressure required to unseat the valve from the closed configuration being greater than fluid pressure required to maintain the valve away from the closed configuration; and a power connector for connecting a power source to the power receptacle, the power connector being configured to reduce risk of a spark when coupling the power connector to the power receptacle.

In some examples, the present disclosure provides a fluid dispensing nozzle. The fluid dispensing nozzle includes: a fluid delivery passage for delivering fluid out from a fluid delivery outlet; a fluid recovery passage for recovering fluid in from a fluid recovery inlet; and a fluid return apparatus for controlling flow of fluid between the fluid delivery passage and the fluid recovery passage, the fluid return apparatus having: a first configuration in which fluid communication between the fluid delivery passage and the fluid recovery passage via the through-passage is inhibited; a second configuration in which fluid communication between the fluid delivery passage and the fluid recovery passage is permitted via the through-passage; and a third configuration in which fluid communication between the fluid delivery passage and the fluid recovery passage is permitted via the through-passage, and in which at least one of fluid delivery out of the fluid delivery outlet or fluid recovery into the fluid recovery inlet is inhibited.

In some examples, the present disclosure provides a fluid dispensing system. The fluid dispensing system includes: a portable source container having at least a container fluid outlet; the pump system disclosed herein, the pump system comprising a rechargeable battery material as the power source; the fluid dispensing nozzle disclosed herein, the fluid dispensing nozzle having a nozzle fluid delivery inlet for receiving fluid from the source container and a nozzle fluid recovery outlet for conveying fluid to the source container; and a fluid delivery conduit for fluid communication from the container interior to the nozzle; a fluid recovery conduit for fluid communication from the nozzle to the container interior; wherein the pump system is coupled to one of the source container or the fluid dispensing nozzle.

### BRIEF DESCRIPTION OF THE DRAWINGS

Reference will now be made, by way of example, to the accompanying drawings which show example embodiments of the present application, and in which:

FIG. 1 is a block diagram of an example liquid dispensing system;

FIG. 2 is a block diagram of a fluid dispensing system comprising a fluid recovery pump;

FIGS. 3-5 illustrate example nozzles of an example fluid dispensing system, including a powered motor;

FIGS. 6-8 illustrate an example power connector suitable for use in an example fluid dispensing system;

FIGS. 9A-9B are cross-sectional views of FIGS. 7-8;

FIGS. 10A-10C illustrate an example arrangement in a nozzle for enabling a power connection;

FIGS. 11-15 illustrate an example fluid return apparatus for controlling fluid flow;

FIGS. 16-17 illustrate an example of a pressure-actuated dispensing valve;

FIGS. 18-19 illustrate an example of a pressure-actuated dual valve;

FIGS. 20-21 illustrate an example of a dual line pump;

FIG. 22 illustrates an example pump configuration for coupling to a source container;

FIG. 23 illustrates an example dispensing system that has been adapted to use a powered pump; and

FIG. 24 illustrates an example dry break connection for coupling a powered pump to a source container.

Similar reference numerals may have been used in different figures to denote similar components.

### DESCRIPTION OF EXAMPLE EMBODIMENTS

The dispensing system of the present disclosure may include one or more elements and/or functions, such as those described in PCT Application Nos. PCT/CA2012/000237, entitled “PORTABLE FLUID CONTAINER ASSEMBLY, FLUID CONNECTOR AND ATTACHMENT”, PCT/CA2005/001367 entitled “PUMP AND NOZZLE LIQUID FLOW CONTROL SYSTEM”, PCT/CA2007/000025 entitled “LIQUID DELIVERY SYSTEM FOR SUPPLYING LIQUID FROM A PORTABLE CONTAINER TO AT LEAST ONE SELECTED REMOTE DESTINATION AND REMOVING VAPOUR FROM THE AT LEAST ONE SELECTED REMOTE DESTINATION”, PCT/CA2007/002081 entitled “VAPOR-RECOVERY-ACTIVATED AUTO-SHUTOFF NOZZLE, MECHANISM AND SYSTEM”, PCT/CA2010/000116 entitled “A NOZZLE FOR USE IN A NON-OVERFLOW LIQUID DELIVERY SYSTEM”, PCT/CA2010/000115 entitled “AUTOMATIC SHUT-OFF NOZZLE FOR USE IN A NON-OVERFLOW LIQUID DELIVERY SYSTEM”, PCT/CA2012/000261 entitled “FLUID RECOVERY DISPENSER HAVING INDEPENDENTLY BIASED VALVES”, PCT/CA2012/000986 entitled “CONTAINER FOR PUMPING FLUID”, PCT/CA/2007/001274, entitled “PORTABLE PUMPING APPARATUS FOR CONCURRENTLY PUMPING LIQUID FROM A SOURCE CONTAINER TO A DESTINATION CONTAINER AND PUMPING VAPOR FROM THE DESTINATION CONTAINER TO THE SOURCE CONTAINER”, PCT/CA/2007/001291 entitled “PORTABLE FLUID EXCHANGE SYSTEM FOR CONCURRENTLY PUMPING LIQUID FROM A SOURCE CONTAINER TO A DESTINATION CONTAINER AND PUMPING VAPOR FROM THE DESTINATION CONTAINER TO THE SOURCE CONTAINER”, and PCT/CA2010/000112 entitled “A NON-OVERFLOW LIQUID DELIVERY SYSTEM”, for example, the entireties of which are all hereby incorporated by reference. Features and functions described in separate documents may be combined in certain embodiments of the present disclosure.

Conventional portable liquid dispensing systems, such as fuel cans, tend to be manually powered (e.g., hand operated, or using a foot pedal). In various examples of the present disclosure, power-assisted dispensing systems are provided. For example, a powered component, such as an electrical motor, may be used to replace or assist manual operation of the dispensing system. It should be understood that any features of liquid dispensing systems, such as those described in the above-referenced PCT applications, may be implemented in a power-assisted dispensing system. Some example features are discussed below.

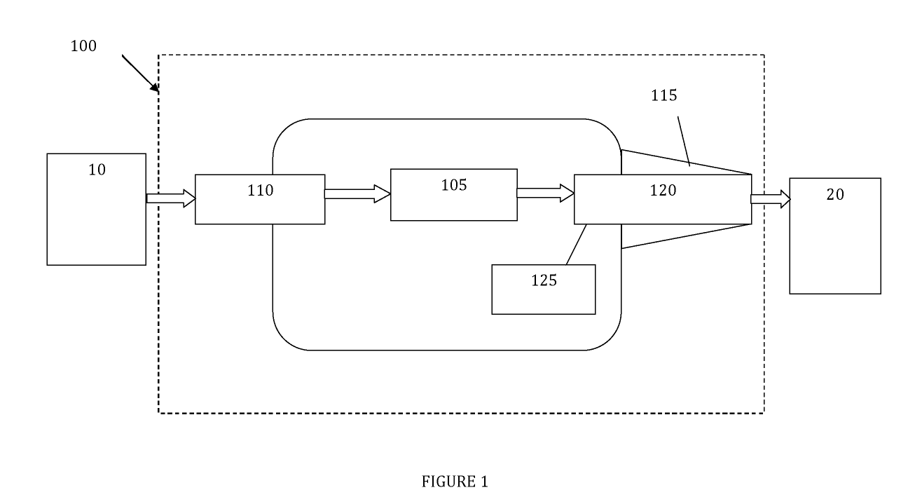

FIG. 1 is a block diagram of an example liquid dispensing system 100 (e.g., a fuel nozzle and pump) for dispensing liquid from a source container 10 (e.g., a fuel reservoir, a portable fuel container or fuel storage tank) to a receiving container 20 (e.g., a fuel tank of a machine, another fuel reservoir, or any other fuel storage enclosure). The fluid flow is represented by white arrows. The fluid may, for example, include a fuel or a chemical. The fluid may be a liquid, vapor, gas, or a mixture thereof.

In this example, the dispensing system 100 includes a pump 105 that pumps liquid from the source container 10 via a conduit 110 (e.g., a fluid hose) and out to the receiving container 20 via an outlet (e.g., a spout 115 of a nozzle). The conduit 110 may be a single-line conduit or a dual-line conduit (e.g., for use with a dispensing system having fluid recovery capabilities, as discussed below). In some examples, a dual-line conduit may include two separate fluid conduits or may have two fluid conduits integrated with each other (e.g., one conduit inside the other)—that is, a single conduit or hose may incorporate two fluid conduits, which may convey fluid in different directions.

The dispensing system 100 further includes a dispensing valve 120 for permitting or inhibiting liquid flow from the spout 115, and a trigger 125 for actuating the dispensing valve 120 (e.g., via mechanical coupling between the trigger 125 and the valve 120). In some examples, the pump 105 may provide the function of the dispensing valve 120, where liquid is prevented from being dispensed when the pump 105 is off and allowed to be dispensed when the pump 105 is on. In some examples, the spout 115 may be provided by the liquid outlet of the pump 105.

In examples where the dispensing system 100 provides fluid recovery as well as fluid delivery, the pump 105 may be a dual-line pump that is able to pump fluid in both directions. Fluid may be pumped by the pump 105 from the source container 10 to the receiving container 20. Any excess fluid (e.g., liquid and/or vapor) from the receiving container 20 may be pumped by the pump 105 from the receiving container 20 back to the source container 10. In some examples, fluid delivery and fluid recovery may be pumped by separate pumps.

Recovery of fluid from the receiving container 20 may prevent unintentional overflow and spillage, as well as reduction of escaped vapors. Excess fluid may, for example, include any fluid in a receiving container 20 that encounters the tip of the spout 115 when the spout 115 is inserted to dispense fluid into the receiving container 20. Thus, what is considered to be excess fluid may be dependent on the depth to which the spout 115 is inserted into the receiving container 20. In some examples, the depth to which the spout 115 may be inserted into the receiving container 20 may be controlled, such as by the size of a spout insertion opening in the receiving container 20, by a feature (e.g., depth-limiting protrusion) provided on the spout 115 and the receiving container 20, by a feature provided at or near the opening of the receiving container 20, and/or by an interface between complementary features on the spout 115 and the receiving container 20. The depth to which the spout 115 may be inserted into the receiving container 20 may be controlled by a depth-inhibiting feature, such as a safety hook, described below.

In some examples, such as where the dispensing system 100 is intended for use in the broad retail market (e.g., for fuelling a gas-powered consumer device from a portable gas can), the system 100 may include one or more plastic components, in order to keep costs low and/or to reduce the mass and weight of the system 100. Two or more components of the system 100 may be formed integrally with each other, or components may be separately formed and assembled during manufacturing.

Fluid may be dispensed using a nozzle, which provides the spout 115. The nozzle may include a fluid delivery passage or fluid delivery conduit in fluid communication with the source container 10 (e.g., via the conduit 110 and pump 105). The fluid delivery passage may have at least one fluid delivery inlet for receiving fluid and at least one fluid delivery outlet for delivering fluid to the receiving container 20. Where the dispensing system 100 has fluid recovery capabilities, the nozzle (which may be a dual-line or dual-conduit nozzle) may include a fluid recovery passage or fluid recovery conduit in fluid communication with the source container 10. The fluid recovery passage may have at least one fluid recovery inlet for receiving excess fluid and a fluid recovery outlet for delivering excess fluid to the source container 10. The fluid delivery outlet and fluid recovery inlet may be positioned at or near the end of the spout 115, which may be at or near a distal end of the nozzle.

The dispensing system may also include an actuator (e.g., a manually-operated trigger or a safety hook, or both, or some other suitable actuator) for controlling fluid delivery and/or recovery. The actuator may be provided on the nozzle.

In a power-assisted dispensing system having a motorized pump, the trigger may control fluid flow via mechanical coupling with the dispensing valve, may control the power (on/off) delivered to the motor and or may provide throttle control in the form of variable speed so as to provide control over the flow rate of the liquid being dispensed. The dispensing valve may be electrically actuated (e.g., a solenoid) or may be manually activated or actuated via the trigger component. The dispensing valve may be entirely inside, outside, or partially inside the spout. Alternatively or additionally actuation of the trigger may open the valve to permit fluid to be dispensed. It may also provide throttle control (e.g., by varying the opening of the dispensing valve and/or by controlling the motor) so as to provide variable flow control.

Unlike conventional manually-operated dispensing systems, in some examples the disclosed dispensing system may rely on operation of the pump, in place of or as an alternative to activation or actuation of the actuator (as in conventional systems) to open the dispensing valve. That is, the valve may be opened by the liquid pressure created by operation (e.g., manual operation or electrical operation) of the pump. An example of such a pressure-actuated valve is described further below. By relying on operation of the pump to open the valve, it may not be necessary to use a mechanical coupling between the trigger and the valve. Elimination or simplification of such mechanical coupling may help to reduce the number of parts in the dispensing system, which may simplify and/or reduce the cost of manufacturing, and may relax the error tolerances of the components.

Power to the motor (for powering a powered pump in a power-assisted dispensing system) may be provided in any suitable form, for example via solar power, a replaceable and/or rechargeable battery pack, a power cord connectable to an external power supply (e.g., a cigarette lighter, car dashboard receptacle, car battery etc.), or any other suitable means. The power source may be connected to the motor via a power connector that provides electrical connection to the power source and that can be coupled to a power receptacle in electrical connection with the motor. In some examples, the motor and/or the power receptacle may be integrated with the pump, for example the motor may be housed within the pump housing.

Any of the dispensing systems described in the above-referenced PCT applications may be adapted to be power-assisted. Similarly, any of the features and functions described in the above-referenced PCT applications may be implemented in a power-assisted dispensing system. Appropriate electrical circuitry may be used to control provision of power to the motor. Some non-limiting examples are discussed herein for illustration.

In some examples, an auto-shutoff mechanism (e.g., as described in PCT/CA2007/002081 and PCT/CA2010/000115) could be provided via electrical and/or mechanical means. The auto-shutoff mechanism may automatically stop operation of the dispensing system when the receiving container is full or nearly full, in order to avoid overflow of the receiving container. For example, a float may be provided on the nozzle or on/in the spout where it could sense the rising liquid in the receiving container and cause activation of a sensor, which in turn may produce a signal to cut off power to the motor. Additionally or alternatively, a sensor circuit (e.g., an infrared, ultrasound or optical sensor circuit), which may be provided on or at the distal end of the nozzle spout, may be completed when liquid in the receiving container reaches a predetermined level. This may be appropriate in situations where the liquid being recovered has sufficient electrical conductivity and other vapors that may be present in the receiving container do not have sufficient electrical conductivity and/or in situations where the liquid being recovered has a particular refractive quality and the vapors that may be presented in the receiving container do not have the same or similar refractive quality. For example, when the predetermined fill height is reached, a signal and/or action could be produced by the sensor to complete or break a circuit, to cut power to the motor. In some examples, a signal produced by the float, may activate (e.g., provide power to) an electromagnet or solenoid that could act to close the valve.

The auto-shutoff mechanism may be a Venturi mechanism, in which backflow of liquid into the dispensing nozzle may mechanically cause the trigger to disengage and stop dispensing. Alternatively or additionally, the Venturi mechanism, when triggered, may deactivate the motor (e.g., by causing power to the motor to be cut off) and/or close the valve at the spout. The Venturi-based auto-shutoff mechanism may disable the valve in the nozzle (e.g., similar to mechanisms found in conventional gas stations) or the vacuum produced by the Venturi effect may be used to move a proximity sensor, diaphragm, piston, pressure sensitive switch, or the like, which in turn causes or produces a signal that causes power to the motor to be cut off and/or that activates a mechanism (e.g., an electromagnet or solenoid) to closes the valve. For a portable dispensing system, the Venturi mechanism may be sized to be sensitive to low flow rates (e.g., lower than the flow rates expected in conventional gas stations).

In some examples, the motor may be disabled if power level in the power source (e.g., a battery pack) falls to or below a predetermined level. At low power levels, the motor may only be able to provide a low flow rate for dispensing liquid, and the auto-shutoff mechanism (e.g., a Venturi mechanism) may be less effective or inoperable at such lower flow rates. At or near the low power cutoff, the dispensing system may provide an indication (e.g., a visual indication, such as a displayed message or turning on a “low power” light) that the power level is low. If the motor is disabled (e.g., due to low power or motor malfunction), the user may still manually activate the pump (e.g., after activating a manual override button to enable the pump). In such a case, the dispensing system may provide notification or warning to the user (e.g., by lighting an appropriate LED or providing an audio or tactile warning) that in continuing manual activation of the pump, auto-shutoff and other overflow protection mechanisms may be less effective or not available. In some examples, the dispensing system may still provide safety functions (e.g., mechanical auto-shutoff mechanisms and/or a safety hook, described below) that prevent unintentional overflow and spillage even in manual operation when the motor is disabled.

In some examples, a safety hook (e.g., as described in PCT application no. PCT/CA2012/000261) may be provided to enable and disable fluid dispensing. For example, the safety hook may be configured to interrupt the power supply to the motor. The safety hook may be located on the spout of a nozzle and may be designed to require the nozzle to be in a proper dispensing configuration and/or orientation before liquid can be dispensed, in order to reduce or prevent spilling of fluid. The safety hook may be biased (e.g., by a biasing member, such as a spring) towards the distal end of the spout in its unactuated position and may be actuated away from the distal end of the spout, for example by properly engaging the spout with the opening of the receiving container. The safety hook may need to be properly engaged with the receiving container (e.g., pushed back by the lip of the opening of the receiving container when the spout is fully inserted into the opening of the receiving container) before liquid dispensing is enabled.

If not properly engaged, the safety hook may disable power to the motor and/or may disable the trigger from actuating the dispensing valve. In some examples, the safety hook may be mechanically coupled to the trigger and/or the dispensing valve, to effect, enable or disable opening of the dispensing valve. In some examples, the safety hook may additionally act to enable or disable the auto-shutoff mechanism. For example, the safety hook may need to be properly engaged before the trigger is mechanically configured to be activatable.

The safety hook may thus prevent unintentional dispensing of fluid when the spout is outside of or not fully inserted into the receiving container. The safety hook may also help to avoid loss of fluid when the spout is removed from the receiving container while still dispensing fluid. For example, the safety hook may be biased to its unactuated position when the spout is removed from the receiving container, such that fluid dispensing may be inhibited, even if the trigger remains actuated.

In some examples, both the safety hook and the trigger may need to be properly engaged in order for power to be provided to the motor. In some examples, the safety hook alone may act to open the valve when the safety hook is properly engaged and close the valve when the safety hook is not properly engaged. In some examples, the dispensing system may not be provided with a trigger component. In this case, proper engagement of the safety hook alone may be sufficient to cause power to be provided to the motor and activate the pump. However, it may be considered to be safer and/or less likely to inadvertently dispense or spill liquid if more than one activation means (e.g., both a safety hook and a trigger, as well as other additional possible activation means) were required to dispense liquid.

The power-assisted dispensing system may be a dual-line system (e.g., having a fluid delivery passage and a fluid recovery passage, similar to that described in PCT application no. PCT/CA2007/000025). A single pump may be used for both liquid delivery and vapor recovery (e.g., a pump having one actively pumped passage and a passive passage (as discussed further below) or a dual pump where the pump has two actively pumped passages), or separate pumps may be used for each of fluid delivery and fluid recovery, such that the dispensing system provides active fluid delivery and active fluid recovery. The nozzle may also be provided with a vapor recovery conduit so that it can perform vapor recovery (e.g., passive and/or active vapor recovery). The dual-line system may include an auto-shutoff mechanism (e.g., a Venturi-based mechanism or a sensor in the fluid recovery passage) to sense when the receiving container has reached the predetermined fill height and deactivate the motor and/or close the valve, for example as described above.

Activation of an automatic spill prevention sensor or mechanism (e.g., a fluid return apparatus (as discussed further below) and/or the auto-shutoff mechanism) may be caused or assisted by the vapor recovery being conducted. For example, a piston or other movable member may be placed in or around the inlet of the recovery conduit (e.g., at or near the tip of the dispensing spout) so that when the liquid in the receiving container rises to cover the inlet of the recovery conduit, the vapor being recovered would assist in the movement of a mechanism and/or the auto-shutoff sensor so as to assist (e.g., speed up) the response time of a fluid recovery function and/or the auto-shutoff. The spill prevention sensor may be sensitive to a specific condition, such as change in pressure or to the change in flow of fluid through the vapor recovery conduit such as a change in speed and/or density of the fluid flow, or a change from the flow of vapor to flow of liquid. The spill prevention sensor may then generate a signal or otherwise respond to the condition to cause power to the electric motor to be cut off. The signal may also activate an electromagnet or solenoid that triggers the auto-shutoff mechanism and closes the valve (e.g., by decoupling the trigger from the valve, where the valve is mechanically actuated by actuation of the trigger).

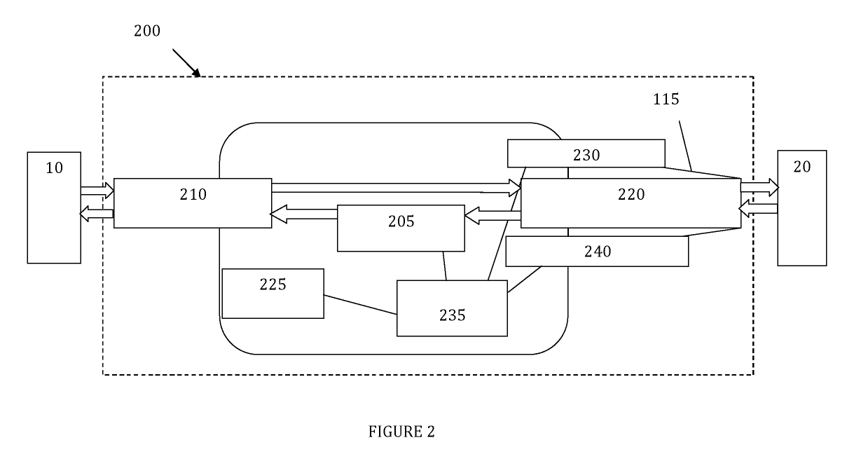

FIG. 2 is a block diagram illustrating an example dispensing system 200 in which instead of a fluid delivery pump or a dual pump, a single fluid recovery pump 205 is used. Fluid flow is represented by white arrows. In this example, the dispensing system 200 may include a fluid recovery component (e.g., a fluid recovery pump 205) that receives fluid from the receiving container 20 via the spout 215 (which may include dispensing valve(s) 220, an auto-shutoff sensor 230 and/or a safety hook 240, for example) and delivers fluid to the source container 10 via a fluid recovery passage (which may be in fluid communication with a conduit 210, such as a two-line fluid hose, to the source container 10). The fluid recovery pump 205 may be powered by a powered component (e.g., a motor 235) and fluid recovery may be activated when a trigger 225 is manually engaged. In the example shown, fluid delivery bypasses the pump 205, however in other examples the passive fluid delivery passage may pass through the pump 205 via a passive fluid through-passage that may be integral to the pump 205 (e.g., in a pump body or housing).

Operation of the fluid recovery pump 205 may cause fluid (typically vapor) to be drawn and/or pumped into the source container (e.g., at a pumping pressure of about 5 psi). In a sealed system, the source container would become pressurized wherein that pressure in the source container would cause liquid from the source container to be displaced and dispensed via the fluid delivery passage and out the spout 220 to the receiving container.

The dispensing system 200 may prevent overflow of the receiving container by having the fluid recovery pump 205 recover any liquid that reaches the distal tip of the spout 220. Since operation of the dispensing system 200 involves active fluid recovery via the fluid recovery pump 205 and no active fluid delivery, overflow of the receiving container may be inherently avoided, even without using any auto-shutoff mechanism. However, an auto-shutoff mechanism (e.g., a Venturi-based mechanism) may still be used to avoid continuing operation of the pump 205 when the receiving container is full. In some examples, the auto-shutoff mechanism may be triggered by the presence of liquid (as opposed to vapor) in the fluid recovery passage. For example, a weighted sensor may be used, which may sense the greater density of liquid (as opposed to vapor) in the fluid recovery passage, and cause the pump 205 to stop.

In some examples, a feedback mechanism (not shown) may be implemented, to indicate to the user that the receiving container is full. For example, a weighted disk may be provided in the fluid recovery passage. When liquid is recovered in the fluid recovery passage (meaning that the receiving container has reached the full liquid level), the greater density of liquid (as opposed to vapor) may cause the weighted disk to spin. The spinning disk may result in tactile feedback, such as a rumbling or shaking motion, and/or may cause activation of a visual indicator (e.g., lighting of a LED) to let the user know the receiving container is full.

The dispensing system 200 may include one or more features described above and in the above-referenced PCT applications, such as a vapor recovery activated auto-shutoff (e.g., as described in PCT application no. PCT/CA2007/002081), an automatic shutoff nozzle (e.g., as described in PCT application no. PCT/CA2010/000115) and/or a safety hook.

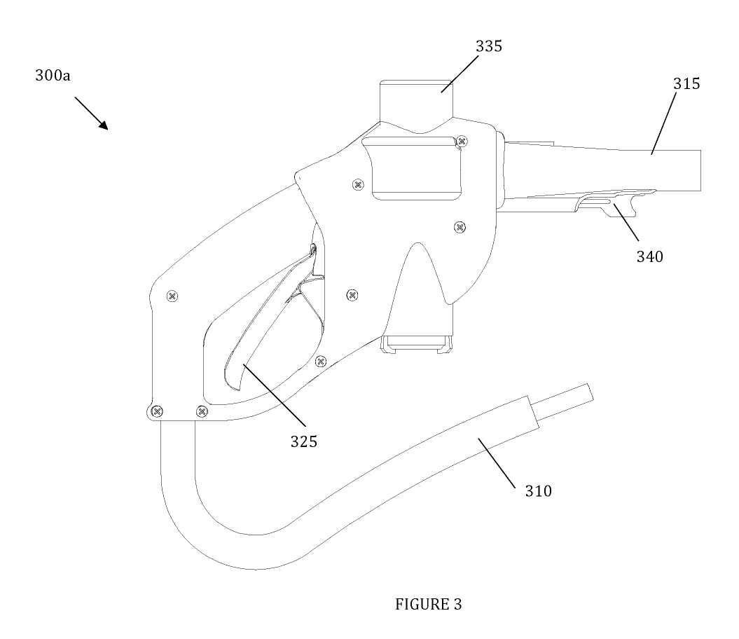

FIGS. 3-5 show example dispensing systems incorporating a powered component (e.g., an electric motor 335) to power a pump 330. In the examples shown, the pump 330 is coupled to the motor 335, however in other examples the pump 330 and motor 335 may be separate from each other. In these examples, the dispensing system may comprise a handheld nozzle 300a, 300b, 300c with a manually-operated trigger 325 and a safety hook 340 (e.g., as described above), a conduit 310 for fluid communication with the source container and a spout 315 for delivering fluid to the receiving container. The nozzle 300a, 300b, 300c may be fully mechanical, fully electrical or partially electrical, partially mechanical in function.

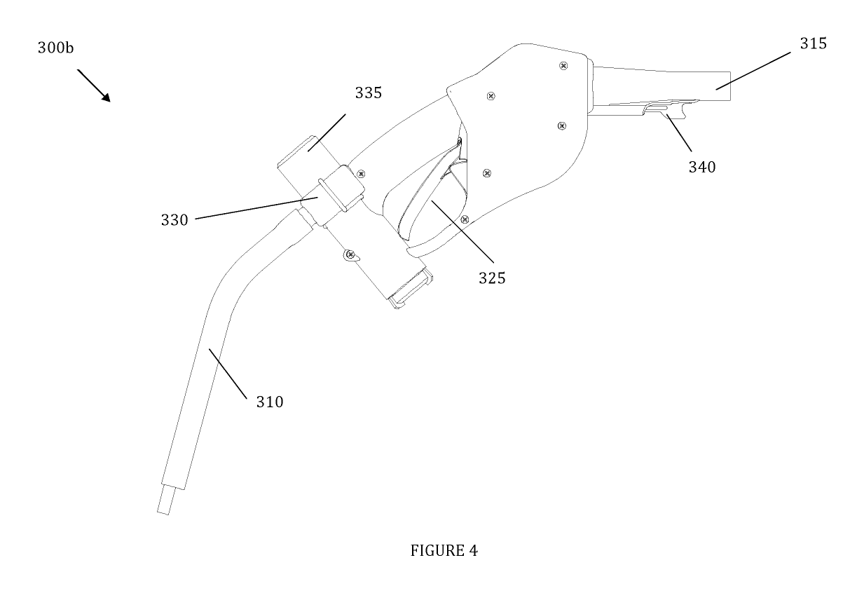

FIGS. 3 and 4 show example dispensing systems in which the motor 335 is mounted or otherwise integrated into the body of the nozzle 300a, 300b. The pump 330 (not shown in FIG. 3) may pump fluid only in the fluid delivery passage, only in the fluid recovery passage, may comprise two pumps each pumping fluid in each passage, or may be a dual pump that pumps fluid in both passages. The conduit 310 may be a single-line hose, or a dual-line hose (e.g., for conveying liquid and vapor). The nozzle 300a, 300b may include a dispensing valve (not shown) (which may be trigger-actuated or may be opened by pressure created by the pump), which may be present in only the fluid dispensing passage, or both the fluid dispensing passage and the fluid recovery passage.

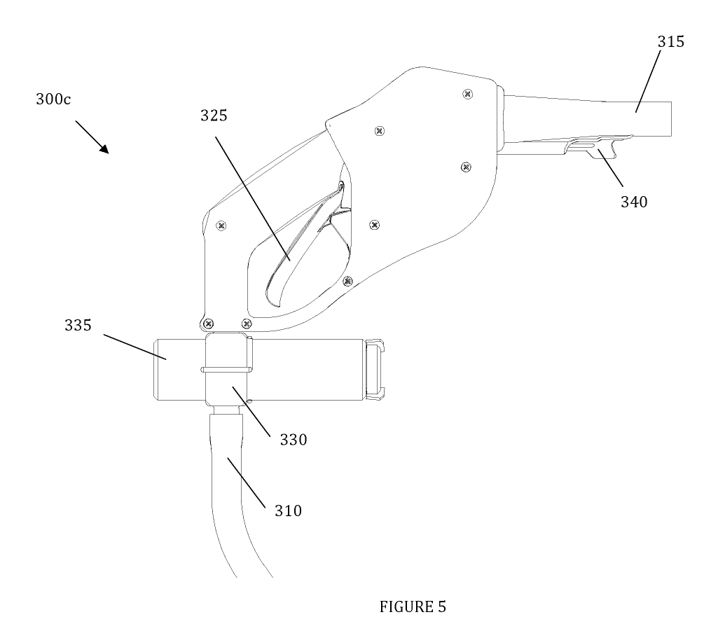

FIG. 5 shows an example dispensing system in which the motor 335 and pump 330 may be coupled to a nozzle 300c (e.g., as an intermediary between a conventional fluid hose and a conventional nozzle) instead of being integrated into the nozzle. The configuration of FIG. 5 may enable any nozzle, for example the nozzles described in PCT applications nos. PCT/CA2010/000115, PCT/CA2010/000116, PCT/CA2012000986, PCT/CA2012/000261 and PCT/CA2007002081, or any other current or future nozzles, to be used in a power-assisted dispensing system.

In other examples (not shown), a conventional dispensing system may be modified to be a power-assisted dispensing system by coupling the motor to other components of the dispensing system upstream of the nozzle (e.g., in the source container or at the outlet of the source container). In operation, dispensing of fluid may require both the motor and the trigger to be activated. For example, the motor may first be activated (e.g., via a manually operated button) to activate the pump and then the trigger may be engaged to open the valve at the spout and enable fluid to be dispensed. In examples where the motor is integrated with the body of the nozzle, activation of the trigger may cause the motor to be activated, and the pressure caused by the pumped fluid may cause the valve to be opened.

The location of the motor (and pump, in examples where the pump is coupled to the motor) may be designed to enable the nozzle to house other components that provide certain functionalities. For example, where the nozzle is designed to house the auto-shutoff mechanism, the motor (and pump) may instead be located externally to the nozzle. In some examples, the motor (and pump) may be provided on or near the source container itself. Generally, the motor and/or pump may be coupled to the source container or the nozzle. In the present disclosure, “coupled” may mean integral with, removably attached to, permanently attached to, or inside of, for example.

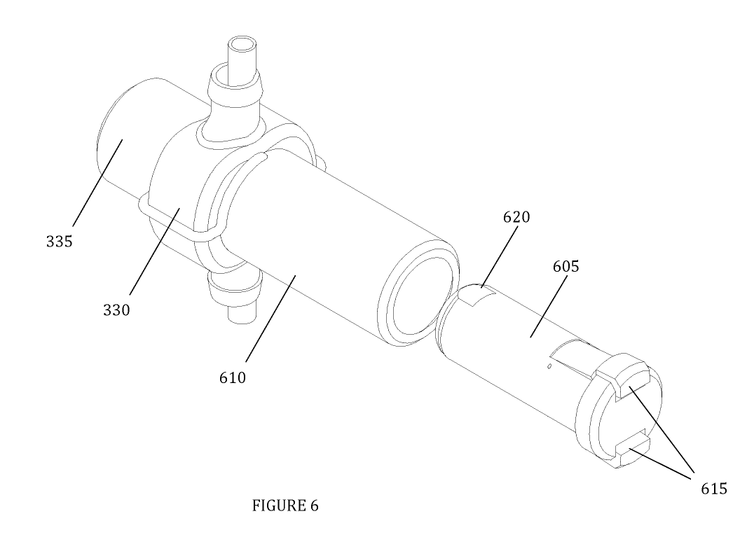

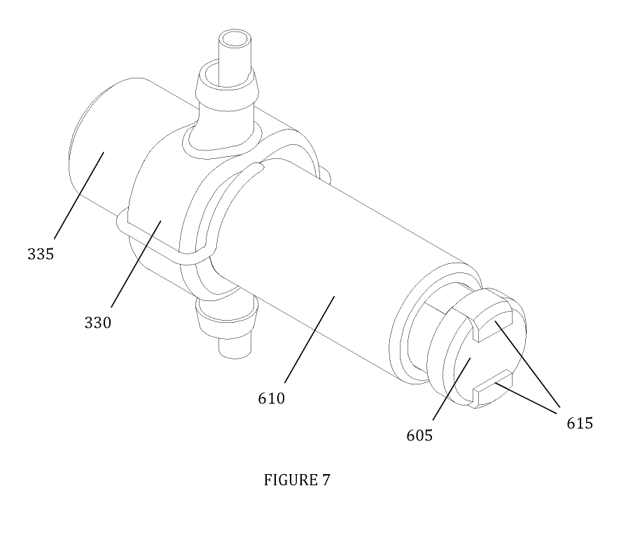

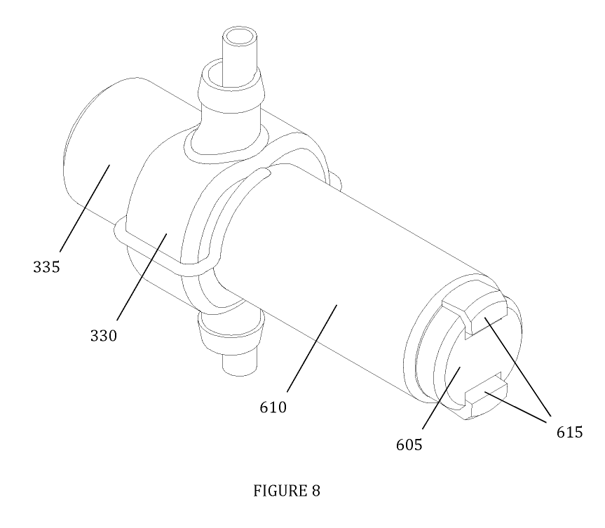

FIGS. 6-8 illustrate an example power connector that may be implemented in a power-assisted dispensing system. The power connector may be used to couple a power source to the motor. The power connector in this example provides a spark-preventing mechanism The power connector may provide electrical connection to a power source. In the example shown, the power connector may be in the form of a removable battery pack 605 (which may be a rechargeable battery pack) that may be coupled to a power receptacle 610 in electrical connection with the motor 335. The power connector may provide electrical connection to other power sources. For example, the power connector may comprise a power cord that can be plugged into an external power source, such as a wall socket or an electrical outlet in a vehicle. In some examples, the power connector may provide both a power cord for plugging into an external power source as well as a battery pack. For simplicity, the present disclosure will describe the power connector in the example form of a battery pack 605.

The power receptacle 610 may be provided with the motor 335 and pump 330, although the power receptacle 610 may alternatively be provided elsewhere in the dispensing system. The power connector may be configured to avoid or reduce the risk of generating a spark when coupling or uncoupling the battery pack 605 from the power receptacle 610. The presence of a spark may be a hazard, particularly when a dispensing system is used to dispense a flammable fluid (e.g., a volatile fuel).

The battery pack 605 includes retaining clips 615, which are biased to a retaining configuration (e.g., outwards from the battery pack 605). The retaining clips 615, in the retaining configuration, may serve to help retain the power connector in the power receptacle 610 (e.g., the retaining clips 615 may be compatible with and received in a corresponding clip receiving portion (not shown) of the power receptacle) when the battery pack 605 is properly received (e.g., fully inserted) in the power receptacle 610. The retaining clips 615 may be moved to a depressed configuration (i.e., away from the retaining configuration) while inserting or removing the battery pack 605 from the power receptacle 610, and before the battery pack 605 is fully inserted or fully removed. The retaining clips 615 may also cooperate with battery terminals 620 of the battery pack 605 to prevent generation of a spark when inserting or removing the battery pack 605.

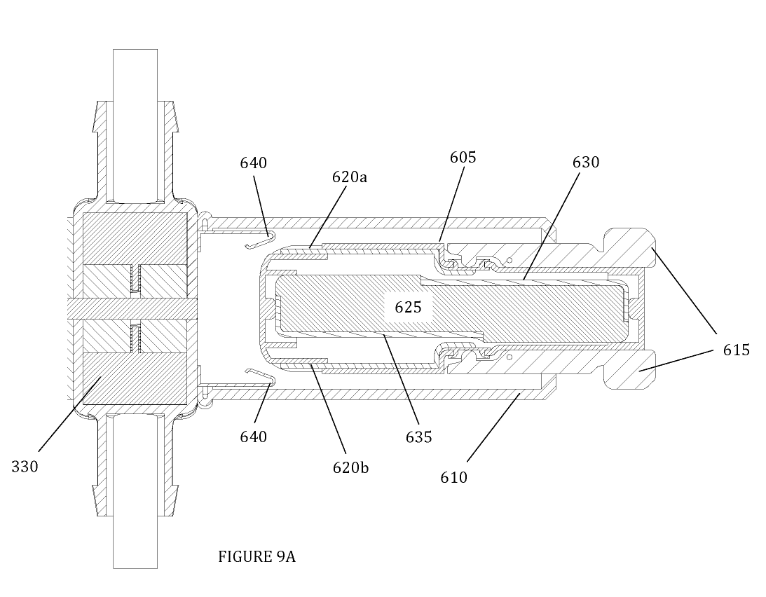

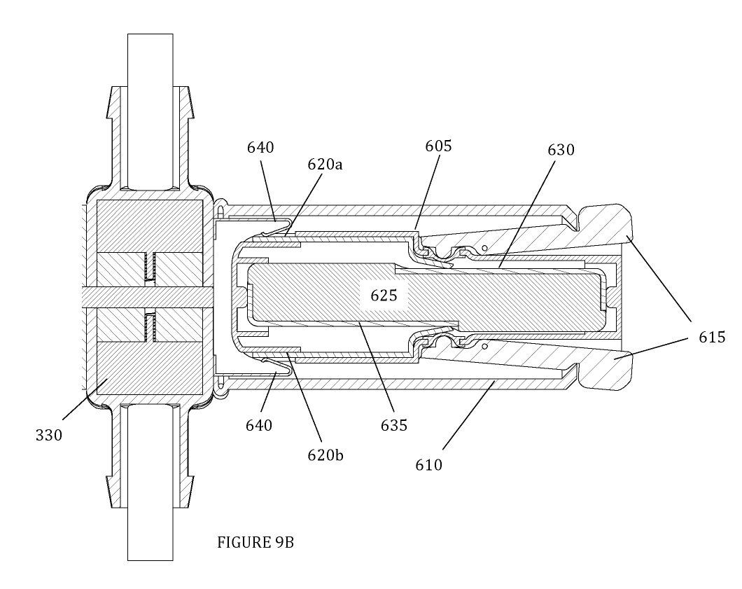

FIGS. 9A-9B are cross-sectional views that show how the retaining clips 615 cooperate with the battery terminals 620 to prevent generation of a spark. The battery pack 605 houses a power source, namely a battery material 625, with a positive lead 630 and a negative lead 635. A positive terminal 620a and a negative terminal 620b (collectively the battery terminals 620) are exposed on the battery pack 605. It should be noted that the polarity of the positive and negative leads 630, 635 and terminals 620a, 620b may be reversed. Power is provided to the motor 335 when the battery terminals 620 are in electrical connection with the respective leads 630, 635 of the battery pack 605 and with the contacts 640 of the power receptacle 610.

As shown in FIG. 9A, the battery terminals 620 may be configured to be biased away from the leads 630, 635. When the retaining clips 615 (which may act as electrical switches) are depressed (e.g., during the process of inserting or removing the battery pack 605 and before the battery pack 605 is fully inserted or removed from the power receptacle 610), there is no electrical connection between the battery terminals 620 and the leads 630, 635. Thus, while the battery pack 605 is making a connection or disconnection with the corresponding contacts 640 of the power receptacle 610, there is no power at the battery terminals 620 and therefore no risk of generating a spark.

As shown in FIG. 9B, when the retaining clips 615 are not depressed (i.e., when the retaining clips 615 are in the retaining position), the retaining clips 615 deflect the battery terminals 620 to come into electrical contact with the respective leads 630, 635. Thus, when the battery pack 605 is installed properly in the power receptacle 610, the retaining clips 615 return to their retaining configuration, enabling power to be provided at the battery terminals 620 and thus to provide power to the motor 335.

The battery housing may serve to completely seal off the battery material 625 from the atmosphere, while enable operation of the retaining clips 615 as described above. For example, the housing may include rubber grommets or other air-tight flexible material to enable the retaining clips 615 to bring the battery terminals 620 into electrical connection with the respective leads 630, 635.

In some examples, there may be only one retaining clip 615 acting on only one battery terminal 620 (e.g., only the positive or only the negative battery terminal). In this case, the one battery terminal 620 may always be in electrical contact with its respective lead, while the other battery terminal 620 is brought into contact with its respective lead only when the retaining clip 615 is in the retaining configuration.

Although described with reference to a battery pack, it should be understood that the spark-preventing mechanism may be provided on any suitable power source including, for example, a rechargeable battery, a solar power source, a connector to an external power source (e.g., a power cable to an external source such as a wall plug, jumper cables, dashboard cigarette lighter or another battery). Additionally, such a power connector may serve as an alternative type of electrical switch, which may be configured to be turned off and/or on in a similar fashion when engaging with a power receptacle so as to prevent the potential of a spark during the installation and disengagement process.

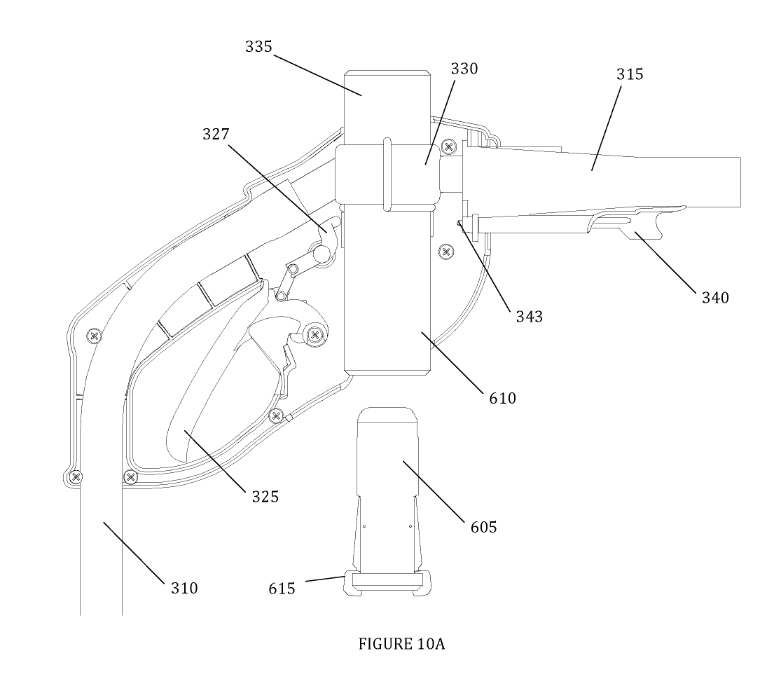

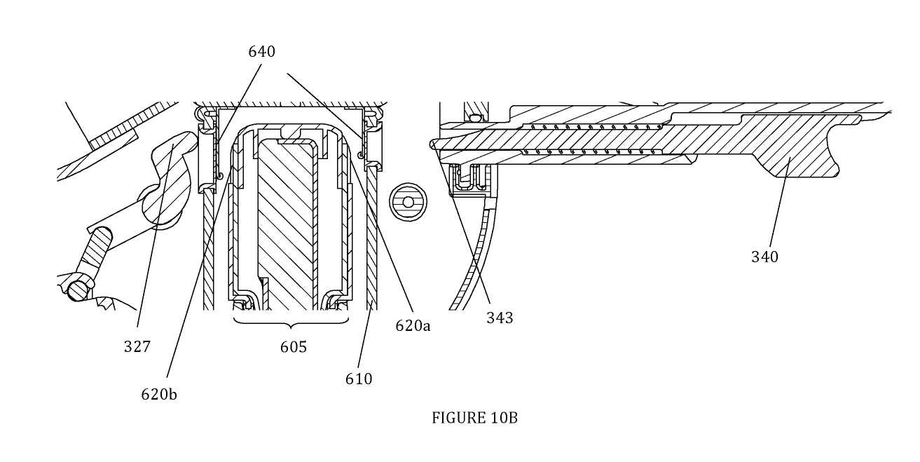

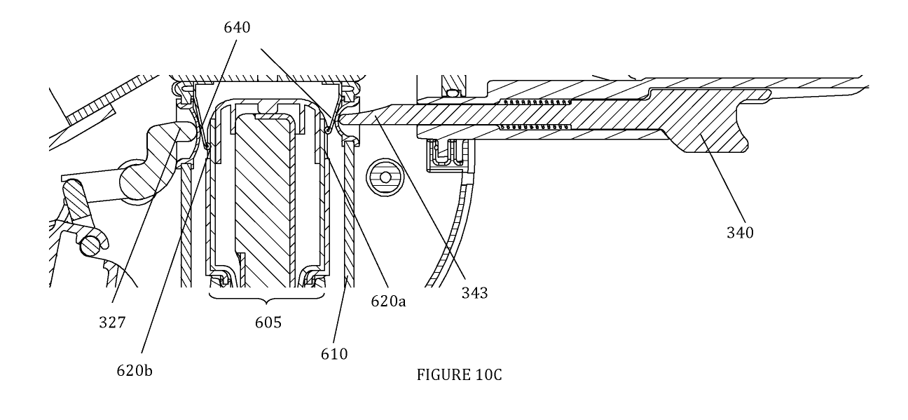

FIGS. 10A-10C illustrate an example arrangement in a nozzle for enabling power to be connected. In this example, the pump 330, the power receptacle 610 and the motor 335 may be provided in the body of the nozzle in a power-assisted dispensing system. The power receptacle 610 receives the battery pack 605, similarly to that described above. The battery pack 605 may include retaining clips 615 that cooperate with battery terminals 620 such that the battery terminals 620 have electrical contacts with the positive and negative leads only when the retaining clips 615 are in the retaining configuration, as described above. In other examples, the battery pack 605 may include conventional retaining clips that may serve to retain the battery pack 605 in the receptacle 610, without providing spark-prevention, as described above.

In the arrangement of FIGS. 10A-10C, the safety hook 340 and trigger 325 of the nozzle provide further safety features that may help to ensure power is provided to the motor 335 only when it is appropriate to do so. The contacts 640 of the power receptacle 610 may be configured to be biased away from the battery pack 605 inserted in the power receptacle 610. Thus, even when the battery pack 605 is properly coupled to the power receptacle 610 and there is electrical power available at the battery terminals 620, the motor 335 may remain unpowered.

As more clearly shown in FIGS. 10B-10C, the trigger 325 and the safety hook 340 may include trigger extension 327 and hook extension 343, respectively. In FIG. 10B, the trigger 325 and the safety hook 340 are not actuated. In FIG. 10C, the trigger 325 and the safety hook 340 are both fully actuated (e.g., by manual operation of the trigger 325 and by proper engagement of the safety hook 340 against the lip of the opening of the receiving container). When the trigger 325 is fully actuated, the trigger extension 327 is moved to deflect one of the contacts 640 to bring the one contact 640 into electrical contact with one of the battery terminals 620b. Similarly, when the safety hook 340 is fully actuated, the hook extension 343 is moved to deflect the other contact 640 to bring the other contact 640 into electrical contact with the other battery terminal 620a. When the contacts 640 are both in electrical contact with the battery terminals 620a, 620b, power may then be provided to the motor 335.

In some examples, the trigger extension 327 and the hook extension 343 may not have direct contact with the contacts 640. The power receptacle 610 may serve to completely seal off the battery pack 605 from the atmosphere once the battery pack 605 is properly inserted into the power receptacle 610. In this way, the contacts 640 may be electrically isolated from the trigger extension 327 and the hook extension 343 within the power receptacle 610. The power receptacle 610 may have flexible rubber grommets (or other air-tight flexible material) that may be deflected by the trigger extension 327 and the hook extension 343 to in turn deflect the contacts 640. Alternatively, switches (e.g., external to the power receptacle 610) may be actuated by the trigger 325 and the safety hook 240. Such these switches may be provided elsewhere in the nozzle and/or dispensing system, where these switches may be configured to operate in a spark free fashion.

Thus, proper actuation of both the trigger 325 and the safety hook 340 is required to power the motor 335. If either the trigger 325 or the safety hook 340 should become unactuated, then power to the motor 335 will immediately be cutoff and pumping will cease, thus stopping dispensing of fluid from the nozzle. Such an arrangement may provide a safety function, to ensure that fluid is not unintentionally dispensed.

Other safety features may be included, for example a weighted switch, such as a mercury switch, may be incorporated into a nozzle or dispenser such that power is provided to the motor only when the nozzle is positioned in a proper dispensing orientation (e.g., spout pointing downwards). In this way, a nozzle may require that it be placed in a proper dispensing orientation in addition to actuation of the trigger 325 and the safety hook 340, so as to provide an additional degree of security, safety and/or spill-proof protection.

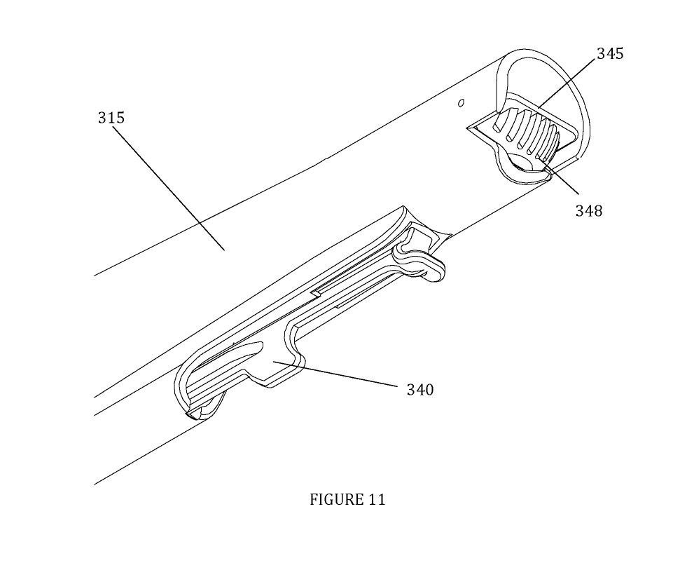

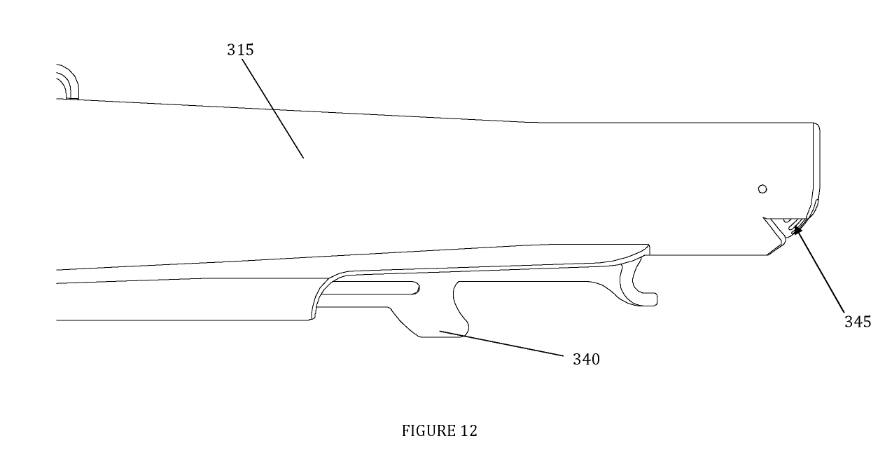

FIGS. 11-15 illustrate an example fluid return apparatus that may be provided inside, at or near the outlet of the dispensing system (e.g., at or near the distal tip of the spout 315) to help reduce or prevent overflow of the receiving container. This fluid return apparatus may be considered as a fluid redirecting feature, in that it may serve to redirect or return pumped fluid directly back to the source container, as explained further below. The fluid return apparatus may also be referred to as a fluid return mechanism, valve or valve system.

The example fluid return apparatus, which may include a butterfly valve 345, may be provided in a dispensing system having fluid delivery, fluid recovery or both fluid delivery and fluid recovery capabilities to assist in fluid flow control and/or to enhance the auto-shutoff mechanism. The butterfly valve 345 may be more generally referred to as a fluid return valve, for use with the fluid return apparatus. This fluid return apparatus may be useful for a Venturi-based auto-shutoff mechanism, and may be used in dispensing systems having passive or active fluid recovery nozzles, such as may be supported by nozzles described in PCT applications nos. PCT/CA2010/000116 and PCT/CA2010/000115.

The fluid return apparatus may include the fluid delivery passage 350 for delivering fluid out of the fluid delivery outlet to the receiving container 20, and the fluid recovery passage 355 for recovering fluid in from the fluid recovery inlet. There may be a through-passage 360 permitting fluid communication between the fluid delivery passage 350 and the fluid recovery passage 355. In some examples, the through-passage may comprise a conduit, an opening between the fluid delivery and fluid recovery passages 350, 355 (e.g., an opening in a common wall shared by the passages 350, 355), or other such configurations enabling fluid communication between the passages 350, 355.

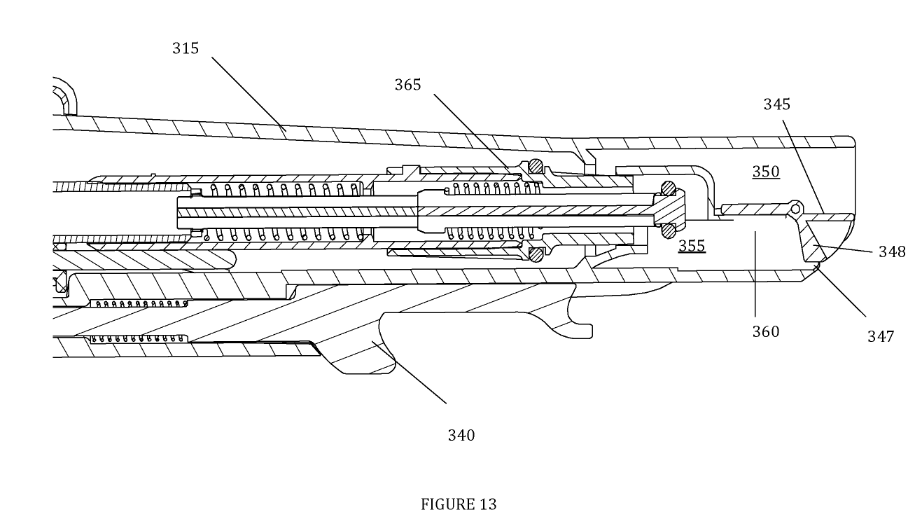

FIG. 13 is a cross-sectional view that illustrates the fluid return apparatus with the butterfly valve 345 in a first configuration (which may also be referred to as a first closed configuration, since the through-passage 360 is closed). The butterfly valve 345 may be in the first configuration by default. For example, the butterfly valve 345 may be biased in the first configuration, such as by using a biasing member (not shown) such as a spring, using an attracting member such as a magnet, using weights, or using a properly weighted portion of the butterfly valve 345 to encouraged the butterfly valve 345 towards the first configuration when the nozzle is placed in a proper dispensing orientation (e.g., spout pointed downwards). For example, there may be an extension 348, which extends at an angle off the main body of the butterfly valve 345. The weight of this extension 348 serves to rotate the butterfly valve 345 towards the first configuration when the spout is pointed in a downward direction.

In FIG. 13, the dispensing valve 365 is in the open configuration (e.g., due to actuation by the safety hook 340 and/or the trigger (not shown)). When the butterfly valve 345 is in the first configuration, the butterfly valve 345 permits fluid to be dispensed from the outlet of the fluid dispensing passage 350 (assuming that the dispensing valve 365 is open), while also permitting vapors to be recovered through the inlet of the fluid recovery passage 355. The extension 348 may act to obstruct fluid flow into the fluid recovery passage 355 from the fluid recovery inlet. There may remain a gap 347 between the extension 348 and the inner wall of the fluid recovery passage 355, adequate to enable air and/or vapor to enter the fluid recovery passage 355 from the fluid recovery inlet, but may obstruct or prevent liquid from entering from the fluid recovery inlet. In the first configuration, the butterfly valve 345 closes the through-passage 360 that would otherwise permit fluid communication between the fluid dispensing passage 350 and the fluid recovery passage 355.

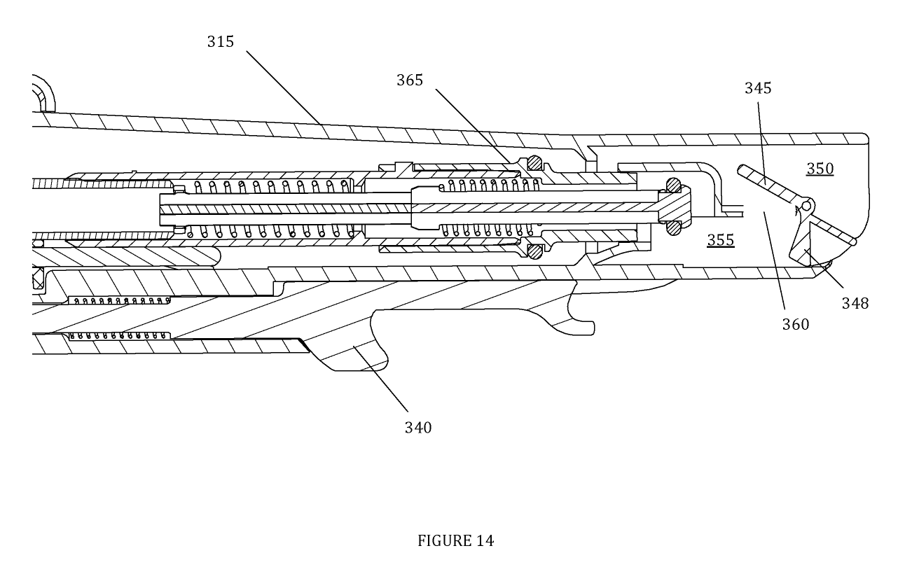

As the liquid level in the receiving container rises, liquid eventually reaches the tip of the spout 315. Any liquid that would otherwise enter the fluid recovery passage 355 may additionally cause the butterfly valve 345 to change to a second configuration, shown in FIG. 14. Any liquid that attempts to enter the fluid recovery inlet may act upon the extension 348 to move the butterfly valve 345 to the second configuration. This movement to the second configuration is expected due to the higher density and viscosity of liquid as compared to vapors. In the second configuration, the butterfly valve 345 uncovers the through-passage 360, permitting fluid communication between the fluid dispensing passage 350 and the fluid recovery passage 355. In the second configuration, a portion of the butterfly valve 345 may protrude into the fluid delivery passage 350, so that it also moderates or impedes fluid flow out of the fluid delivery passage 350 and into the fluid recovery passage 355, since the portion of the butterfly valve 345 at least partially occludes the fluid delivery passage 350.

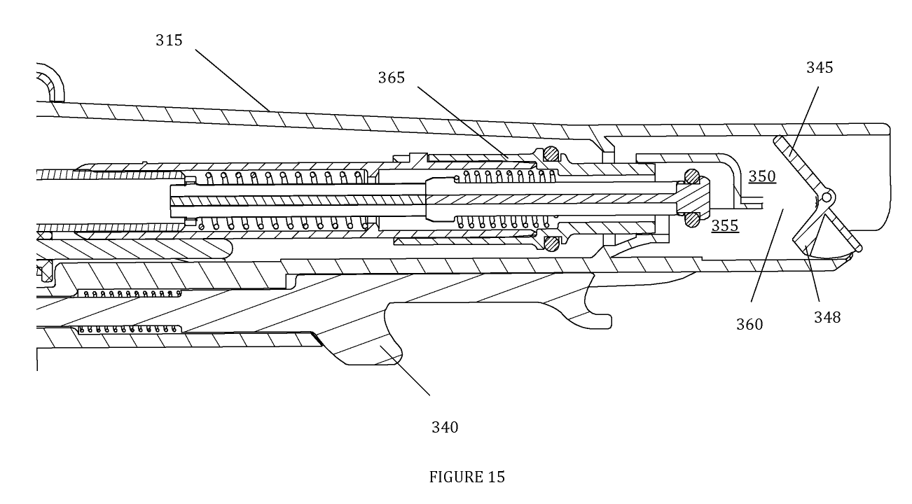

The butterfly valve 345 may be further moved to a third configuration, shown in FIG. 15. In the third configuration (which may be referred to as a second closed configuration, since the fluid delivery and fluid recovery passages 350, 355 are closed), the through-passage 360 remains uncovered and the butterfly valve 345 may inhibit or prevent fluid from being dispensed out of the fluid dispensing passage 350 (e.g., from the fluid dispensing output into the receiving container) and may inhibit or prevent fluid from being recovered into the fluid recovery passage 355 (e.g., into the fluid recovery inlet from the receiving container). The butterfly valve 345 may fully occlude the fluid delivery passage 350 and may close the gap 347 with the fluid recovery passage 355. In some examples, the butterfly valve 345 in the third configuration may provide liquid-tight seals against both the fluid dispensing passage 350 and the fluid recovery passage 355. Thus, the butterfly valve 345 in the third configuration may redirect fluid from being conveyed or pumped through the fluid dispensing passage 350 directly to the fluid recovery passage 355 and on back to the source container.

The butterfly valve 345 may also be moved between its configurations by an actuator, such as the safety hook 340. For example, there may be a mechanical coupling (not shown), such as a gear system, to translate actuation of the safety hook 340 into movement of the butterfly valve 345. For example, the butterfly valve 345 may be in the third configuration when the safety hook 340 is not actuated (e.g., not properly engaged with the receiving container), and may be moved through the second configuration to the first configuration when the safety hook 340 becomes properly engaged and actuated. The butterfly valve 345 may be manually operable using any other suitable actuator, for example the trigger (not shown).

It should be noted that when the butterfly valve 345 is in the second configuration, a portion of the butterfly valve 345 is lifted into the stream of fluid flowing through the fluid dispensing passage 350, thus moderating or decreasing the fluid flow out of the fluid dispensing passage 350. The butterfly valve 345 may be maintained in the second configuration (e.g., via a linkage, cable, gear or ratchet system, in cooperation with an actuator such as the safety hook 340). In some examples, the butterfly valve 345 may be moved from the second configuration to the third configuration by the force of fluid flowing in the fluid dispensing passage 350 and thus be maintained in the third configuration (e.g., by fluid pressure).

In some examples, a fluid return apparatus may comprise a float, which may be attached to an extended surface. The float may provide weight, when unsupported by any liquid (e.g., liquid in a receiving container or liquid in the fluid recovery passage), to maintain the fluid return apparatus in its first configuration. The float may then actuate the fluid return mechanism into a second configuration as it begins to float and is lifted by a rising liquid (e.g., liquid rising in a receiving container or as liquid enters the fluid recovery passage).

The use of this fluid return apparatus may help to improve the response of the auto-shutoff mechanism In the absence of this example fluid return apparatus, the auto-shutoff mechanism may be reliant on sensing a change in fluid drawn through the fluid recovery passage to the auto-shutoff mechanism (e.g., a Venturi-based mechanism or other suitable fluid recovery-activated auto-shutoff mechanism, such as described in PCT application no. PCT/CA2010/000115). Since vapors and gases are compressible and expandable, there could be a delay in the response of the auto-shutoff mechanism as the vacuum pressure builds to draw in the excess or recovered fluid. Depending on where the auto-shutoff mechanism is located along the fluid recovery passage, this delay may or may not be significant. This delay may be especially true of systems relying on passive vapor recovery, in which vapor recovery is generated and/or supported by the negative pressure created in a source container as fluid in the source container is dispensed. During this delay, fluid may continue to be dispensed into the receiving container, with a possible risk of overflow.

The example fluid return apparatus may help to reduce or eliminate this risk of overflow by being more responsive to the presence of liquid in the receiving container reaching the distal tip of the spout. When liquid reaches the tip, the butterfly valve will change to the second configuration and may progress to the third configuration, as described above. Vapor easily passes by the butterfly valve in the first configuration, but as liquid begins to enter the fluid inlet of the fluid recovery passage, the hydrodynamic forces actuate the butterfly valve into the second and eventually third configurations. Thus, liquid is stopped from being dispensing into the receiving container but is instead redirected back towards the source container. By redirecting fluid from the fluid dispensing passage directly to the fluid recovery passage in the third configuration, the fluid return apparatus also helps to improve the responsiveness of the fluid recovery function. Since vapours and gases are compressible and expandable, there may be a delay in the recovery of fluid as the vacuum pressure within the system builds in the fluid recovery passage to effectively draw in the excess fluid from a destination container. Again, this delay may be especially true of systems relying on passive vapor recovery. The use of such a fluid return apparatus may also result in the location of the auto-shutoff mechanism being of less concern. Thus, the auto-shutoff mechanism may be located more remotely from the dispensing outlet, for example further towards the proximal end of the nozzle, towards the source container, or even on or in the source container.

In some examples, where the butterfly valve is operable via an actuator (e.g., the safety hook or trigger), the fluid return apparatus may be used in place of a dispensing valve to control fluid dispensing. The fluid return apparatus, when operable by an actuator, may enable the magnitude of fluid flow from the fluid delivery outlet to be controlled or moderated by controlling the amount by which the fluid delivery passage is occluded when the butterfly valve is in the second configuration.

In some examples, the use of the fluid return apparatus may allow for the design of a relatively simple and basic spill-proof or spill-resistant dispensing system, which may not require a typical standard sensor or an auto-shutoff deactivation means. Use of the fluid return apparatus may result in a spill-proof or spill-resistant system due to the fact that the liquid being pumped is redirected back to the source container upon detecting liquid reaching the tip of the nozzle. The liquid being pumped would no longer be filling the receiving container so the risk of overflow would be greatly reduced or eliminated, even in the absence of a typical sensor or an auto-shutoff mechanism. The fluid return apparatus alone may be able to appropriately respond to the rising liquid (e.g., to stop the flow of liquid being dispensed into the receiving container). Thus, the fluid return apparatus, may be sensitive to the presence of rising liquid, may be responsive to the rising liquid reaching a certain level, and may act to inhibit or prevent further dispensing of liquid. Such a fluid return apparatus may be useful in that it may be able to perform these functions using a relatively simple design, rather than requiring multiple complex components.

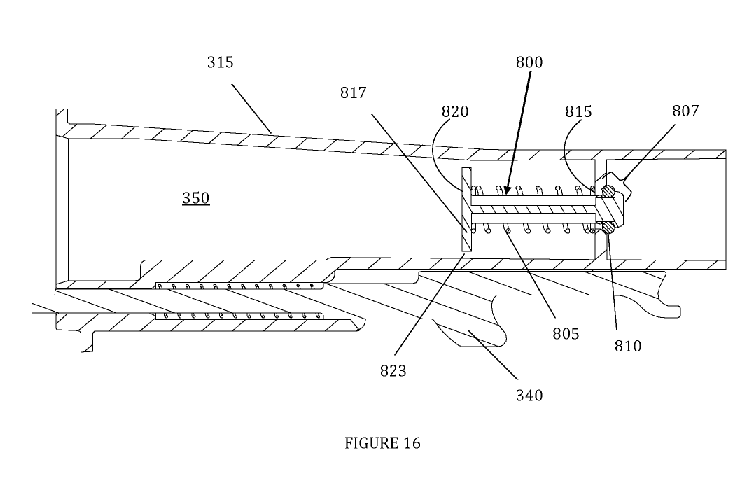

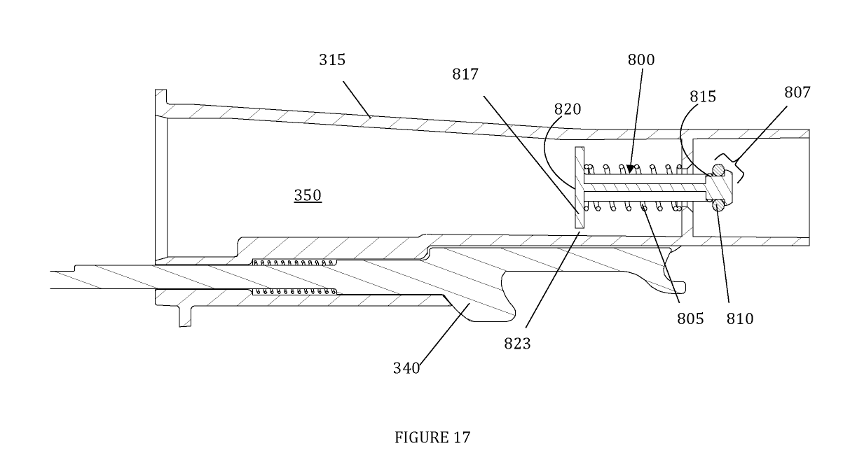

FIGS. 16-17 are cross-sectional views of the distal end of an example spout 315, in which the dispensing valve is a pressure-actuated valve 800. In the example shown, the dispensing system only has a fluid delivery passage 350 for dispensing fluid out of the fluid delivery outlet, and the pressure-actuated valve 800 is provided to control dispensing of fluid from the fluid delivery passage 350. Where the valve 800 is used to control fluid delivery of fluid, the valve 800 may also be referred to as a fluid delivery valve. The pressure-actuated valve 800 may be configured to be biased (e.g., by a biasing member 805, such as a spring) to a closed configuration in which the valve 800 has a seal portion 807 forms a liquid-tight seal against the inner wall of the fluid delivery passage 350 (e.g., using an O-ring 810) and liquid is inhibited from being dispensed out of the fluid delivery outlet. The pressure-actuated valve 800 may be unseated from its closed configuration by liquid pressure in the fluid delivery passage. Once unseated from the closed configuration, the pressure-actuated valve 800 may be considered to be opened in that fluid flow out of the fluid delivery passage 350 may be permitted.

The pressure required to move the valve 800 is based on the area of the valve 800 on which the pressure is acting. The valve 800 presents two areas on which liquid pressure may act, a smaller area 815 (e.g., presented at the seal portion 807) (which may also be referred to as a first area) and a larger area 820 (e.g., presented at a proximal disk 817) (which may also be referred to as a second area). Generally, the areas on which liquid pressure may act may be presented by surface(s) or frontal area(s) that are presented to the fluid in the fluid delivery passage 350. The areas 815, 820 may be a combination of two or more distinct surfaces and/or may be formed by non-planar surface(s). When the pressure-actuated valve 800 is in the closed configuration there is a gap 823 between the proximal disk and the inner wall of the fluid delivery passage 350, permitting liquid to pass the proximal disk 817. Thus, pressure on either sides of the proximal disk 817 are equivalent, however there is a pressure differential on either sides of the seal portion 807. This fluid differential results in a force that acts on the smaller area 815, causing the valve 800 to become unseated from the closed configuration when the biasing force of the biasing member 805 is overcome by the force of the fluid pressure. Once the valve 800 is unseated, a pressure differential is present on either sides of the proximal disk 817, and the force due to fluid pressures will act on the larger area 820 to maintain the valve 800 away from the closed configuration. Once the valve 800 is unseated, the hydrodynamic forces acting on the larger area 820 will hold the valve 800 away from the closed configuration until liquid flow in the fluid delivery passage 350 ceases and pressure drops or is equalized.

It should be noted that greater differential in fluid pressure is required to act on the smaller area 815 in order to exert the same force that a lesser pressure differential would exert on the larger area 820. Thus, the configuration of the pressure-actuated valve 800 means that less pressure differential is needed to hold the valve 800 open than to initially unseat the valve 800. This provides a higher opening pressure and a lower dispensing pressure, with the result that after exerting greater effort (e.g., as exerted by the pump) to initially open the valve 800, less effort is required to keep the valve 800 open. Such an arrangement helps reduce the risk of unintentionally opening the valve 800 while reducing the effort and energy (e.g., electrical power) required to keep the valve 800 open.

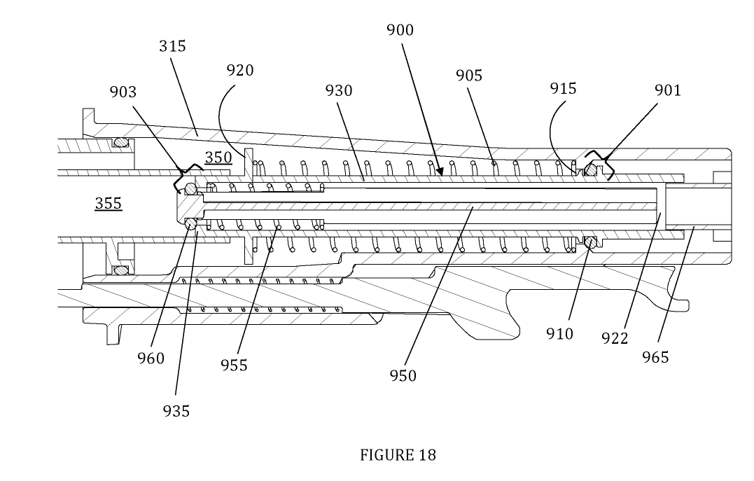

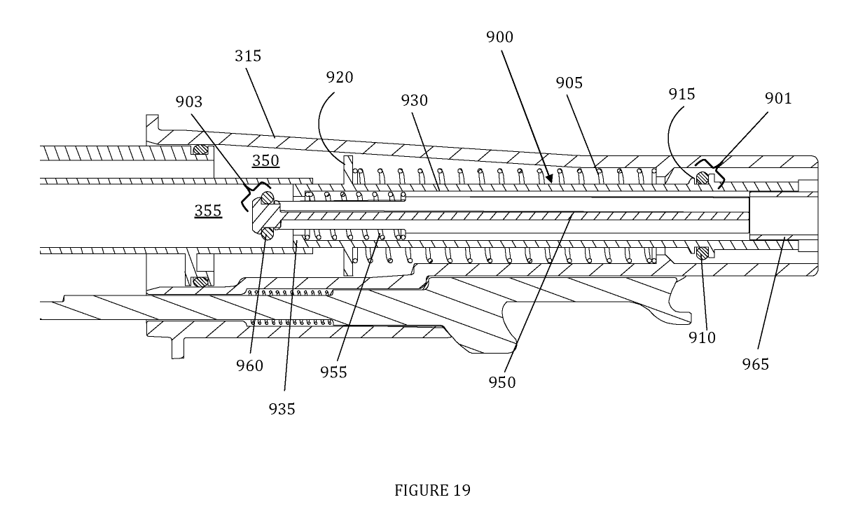

A similar principle may be used to implement a pressure-actuated dual valve 900, as shown in FIGS. 18-19, which may be used for a dispensing system having fluid recovery capabilities. Similarly to the pressure-actuated valve 800 described above, the pressure-actuated dual valve 900 may be configured such that a greater pressure is required to unseat the valve 900 than to keep the valve 900 open.

In this example, the fluid recovery passage 355 is provided within the fluid delivery passage 350, and the valve 900 is situated to control fluid flow in both the fluid delivery passage 350 and the fluid recovery passage 355. The valve 900 includes a first valve portion 901 that controls fluid flow in the fluid delivery passage 350 and a second valve portion 903 that controls fluid flow in the fluid recovery passage 355. The first valve portion 901 may include a valve body 930. The first valve portion 901 is biased towards a first closed configuration by a biasing member 905 (e.g., a first spring). In the first closed configuration, the first valve portion 901 provides a liquid/air-tight seal (e.g., via an O-ring 910) against the inner wall of the fluid delivery passage 350. The second valve portion 903 is biased to a second closed configuration by another biasing member 955 (e.g., a second spring), and in the second closed configuration provides a liquid/air-tight seal (e.g., via another O-ring 960) against a sealing surface 935 provided in the wall of the valve body 930. The second valve portion 903 may be attached to an inner stem 950. In this example, the first and second valve portions are biased in substantially opposing directions, and are aligned substantially along parallel longitudinal axes (e.g., the first valve portion is biased closed towards the distal end of the spout 315 while the second valve portion is biased closed away from the distal end of the spout 315). Movement of the first and second valve portions may be along substantially parallel axes or substantially coaxial, and may be in substantially opposing directions.

In the second closed configuration, there is a gap 922 between the distal end of the inner stem 950 and a stopping member 965, the function of which will be described further below. Fluid is able to flow in the fluid delivery passage 350 about the valve 900 since the proximal end of the valve 900 is not fluid-tight against the fluid delivery passage 350. The pressure required to unseat the first valve portion 901 is based on a first area, in this case the smaller area 915 presented by the seal portion of the first valve portion 901. When the first valve portion 901 is in the first closed configuration, this smaller area 915 is subjected to fluid pressure in the fluid delivery passage 350. When the fluid pressure differential results in a force that is sufficient to overcome the biasing force of the biasing member 905, the first valve portion 901 is unseated from the first closed configuration. Unseating of the first valve portion 901 causes the inner stem 950 to move with the valve body 930 and first valve portion 901, decreasing the gap 922. When the inner stem 950 abuts against the stopping member 965, further movement of the inner stem 950 is prevented. At this point, the second valve portion 903 in the fluid recovery passage 355 is unseated away from the second closed configuration as the first valve portion 901 continues to move further away from its seat.

As in the valve 800, the valve 900 may be designed to have a dispensing pressure lower than the initial opening pressure. Once the first valve portion 901 is unseated, fluid pressure will act on a second area, in this case the larger area 920 of the valve body 930 to keep the first valve portion 901 open. Less force due to fluid pressure is required to be exerted on the larger area 920, as compared to the smaller area 915, to overcome the biasing force of the biasing member 905. Similarly to the valve 800 described above, the areas 915, 920 may generally be the areas (e.g., presented by surface(s) or frontal area(s)) that are presented to the fluid in the fluid delivery passage 350. The areas 915, 920 may be a combination of two or more distinct surfaces and/or may be formed by non-planar surface(s).

It should be noted that compressing both biasing members 905, 955 (in order to unseal both the fluid delivery passage 350 and the fluid recovery passage 355) requires greater force than compressing the biasing member 905 of the first valve portion 901 alone. By providing a larger area 920 for the liquid pressure to act on, the pressure that is required to generate a force to compress both biasing members 905, 955 is reduced. If properly sized, it may even take less pressure to unseal the fluid recovery passage 355 than the pressure required to initially unseal the fluid delivery passage 350.

This gap 922 between the inner stem 950 and the stopping member 965 may be useful to allow first and second biasing members 905, 955 to bias the first and second valve portions independently of each other. The presence of the gap 922 may reduce the initial cracking pressure required to unseat the first valve portion 901, and may result in staggered, offset or sequential unseating of the first and second valve portions. For example, in response to sufficient fluid pressure in the fluid delivery passage 350, the first valve portion may be unseated prior to the second valve portion. In some examples, the gap 922 may be designed to be relatively small, to reduce this time difference between opening of the first and second valve portions. In some examples, there may not be any gap, such that there may be negligible time difference between opening of the first and second valve portions. In some examples, the gap 922 may be designed to be relatively large, such that an intermediate configuration may be defined, in which the first valve portion is opened but not the second valve portion (e.g., by controlling the amount of fluid pressure in the fluid delivery passage 350), such that fluid delivery is permitted but fluid recovery is inhibited. Such intermediate configuration may be useful, for example, where overflow of fluid is desired or where recovery of excess fluid is not desired.

Although other positions and configurations are possible for the valve 800, 900, it may be desirable to position the valve 800, 900 relatively distal, near or at the dispensing end of the spout 315, to help reduce the amount of potential fuel lost that may be trapped between the closed valve portions and the end of the spout 315 (e.g., fuel loss such as dripping and/or draining of fuel from the spout after the valves are closed).

In both examples of pressure-actuated valves 800, 900, the effect is that the pumping pressure is reduced once the initial opening pressure is overcome. Reducing the pumping pressure may help to reduce the stress and strain on component parts, and may further help to reduce the power requirements (e.g., electrical power or manual strength) needed to operate the pump. The areas that are exposed to fluid pressure may be designed (e.g., by selecting surface(s) to achieve an appropriate area) to achieve a desired pressure required to initially unseat the valve 800, 900 and a desired pressure required to keep the valve 800, 900 open. Although described in terms of positive pressure exerted in the fluid delivery line, in some examples the valves 800, 900 may be configured to be unseated by negative pressure (e.g., a lower pressure or vacuum in the fluid recovery conduit and/or at the fluid recovery outlet), in a similar fashion. For example, when configured to be unseated by negative pressure, the unseating may be the result of negative pressure acting on the sealing portion 807 of the valve 800, and the second valve portion 903 of the valve 900. Additionally, in these embodiments of the valve 800, 900, the larger areas 820, 920 may be located upstream from sealing portions 807, 901, 903 but these larger areas 820, 920 may alternatively be located downstream from sealing portion 807, 901, 903.

Such pressure-actuated valves may be provided in power-assisted dispensing systems, or manually operated dispensing systems. One or more such pressure-actuated valves may be configured and implemented to work in any suitable dispensing system including, for example, that described in PCT application no. PCT/CA2013/050676 entitled “SYSTEM AND APPARATUS FOR DISTRIBUTING FUEL, AND METHODS THEREFORE”. In examples where pressure-actuated valves are implemented in a quick disconnect or dry-break connection, as described in PCT application no. PCT/CA2013/05067, even after the valves in each half of the dry-break connection are engaged with each other, the valves may remain closed until the pressure in the fluid delivery passage(s) and/or fluid recovery passage(s) are sufficient to open the pressure actuated valves.

Such pressure-actuated valves may also be combined with other components and/or systems to provide additional advantages. As discussed above, the fluid return apparatus may be located in a number of useful locations throughout a dispensing system. For example, in a dispensing system where the valve is a pressure-actuated valve, a fluid return apparatus may be positioned within the system such that it may act as an auto-shutoff mechanism In some examples, the fluid return apparatus (e.g., comprising a butterfly valve) may be located between the pump and a pressure-actuated valve (e.g., either a single or a dual pressure-actuated valve). In its first configuration, the fluid return apparatus may close a through-passage to inhibit fluid communication between a fluid delivery passage and a fluid recovery passage. In this first configuration, the fluid return apparatus may act to maintain pressure within the fluid delivery passage such that pressure within the fluid delivery passage can act to open the pressure-actuated valve(s). Additionally, the fluid return apparatus may be configured such that pressure within the fluid delivery passage may act on the fluid return apparatus to force the fluid return apparatus towards the first configuration, and this force may promote sealing of the through-passage. As liquid is dispensed and the liquid level in the receiving container rises, liquid will eventually reach the tip of the spout to enter the fluid recovery passage. The presence of liquid in the fluid recovery passage will act to reconfigure the fluid return apparatus to its second configuration, in which case liquid will be redirected to flow from the fluid delivery passage directly into the fluid recovery passage. This may cause the pressure in the fluid delivery passage to drop below the pressure required to keep the pressure-actuated valve(s) open. The fluid return apparatus may thus act as an auto-shutoff mechanism, closing the fluid delivery outlet.

In some examples, the fluid return apparatus may serve the function of a pressure relief valve. While conventional pressure relief valves are responsive to the pressure being monitored, the fluid return apparatus may serve to response to a condition that is indirectly and/or directly caused by the pressure being monitored or maintained. For example, the fluid return apparatus may be responsive to a predetermined condition (e.g., a predetermined liquid level in the receiving container) that is caused by fluid pressure, and act to relieve the pressure (e.g., redirect fluid such that fluid pressure drops, as described above).

Generally, the features and functions described in the present disclosure may be implemented in various dispensing systems having various configurations. For example, the dispensing system may have various pump configurations including a single fluid delivery pump, a single fluid recovery pump, having two or more individual pumps, or having a dual pump. The pump(s) may include a rotary pump, a centrifugal pump, or any other suitable means of pumping. In some examples, the pump(s) may be replaced by other suitable pumping mechanisms, for example a bellows or piston mechanism, which may generally be referred to as pumps.

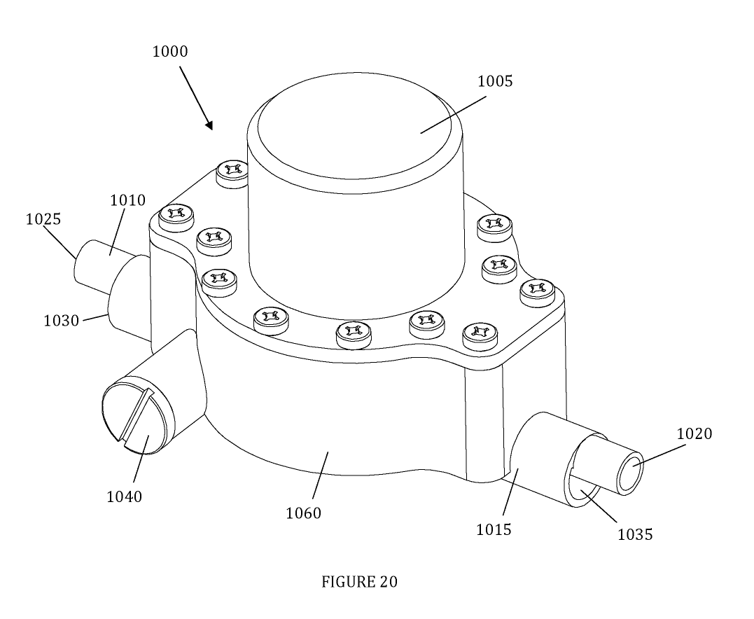

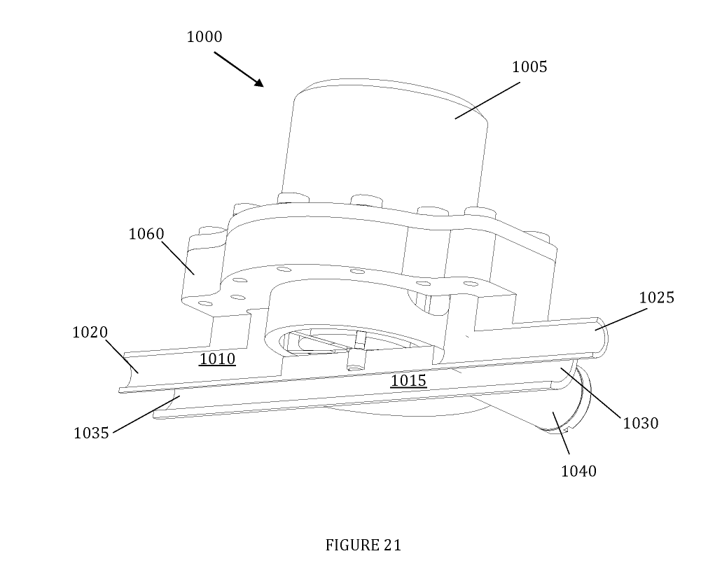

FIGS. 20-21 illustrate an example pump 1000 that may be suitable for use in a dispensing system of the present disclosure. In this example, the pump 1000 may be a liquid or vapor pump (or be capable of pumping both liquid and vapor). The pump 1000 includes a pump body 1060, an electric motor 1005 and a two-line conduit that may enable fluid delivery and fluid recovery in the single pump 1000. One passage, for example the fluid recovery passage 1010, may be integrated with (e.g., provided inside) the other passage, for example the fluid delivery passage 1015. Each of the fluid recovery passage 1010 and the fluid delivery passage 1015 may be in fluid communication with the respective fluid recovery passage and fluid delivery passage of the nozzle, for example as described above. The fluid recovery passage 1010 is provided with a fluid inlet 1020 and a fluid outlet 1025 Similarly, the fluid delivery passage 1015 is provided with a fluid inlet 1030 and a fluid outlet 1035. Although referred to as fluid delivery and fluid recovery passages, the pump 1000 may more generally have first and second fluid passages or fluid portions for conveying or conducting fluid, regardless of the direction of fluid flow.

The pump body 1060 may house a pumping portion that actively pumps fluid through the fluid recovery passage 1010, but that does not pump fluid through the fluid delivery passage 1015 (or vice versa).

The pump 1000 may include a pressure-limiting valve 1040 to limit the pressure of the fluid being pumped. The pressure-limiting valve 1040 may be any suitable pressure-limiting valve designed for pumps. In the example shown, the pump 1000 may be configured as a fluid recovery pump only (e.g., for implementation in the example system of FIG. 2). The pressure-limiting valve 1040 may serve to limit the pressure to about 5 psi, for example, so as to avoid overinflating or over-pressurizing the source container.

An example operation of the pump 1000 for active pumping of vapor and passive delivery of liquid (e.g., as in the system of FIG. 2) is now described. The system may be a closed or sealed system comprising a source container, the pump 1000, a fluid conduit (e.g., a dual-line hose) and a dual-line nozzle, such that active pumping of vapor into the source container results in dispensing of fluid, as described below. The pump 1000 may be allowed to run continuously. When the dispensing valve in the nozzle is closed, the pump 1000 will actively pump vapor into the source container, thus pressurizing the source container. Once a predetermined pressure, as set by the pressure-limiting valve 1040, is reached (e.g., a pressure of about 3-10 psi, where 5 psi is considered adequate for fluid dispensing), the pressure-limiting valve 1040 in the pump 1000 would open, resulting in recirculation of fluid (e.g., vapor) within the pump 1000. When the dispensing valve in the nozzle is opened (e.g., upon manual actuation of a trigger and/or safety hook), a pressure differential is created between the nozzle and the source container, and the higher pressure built up in the source container will act to force the liquid out of the source container to be dispensed out of the nozzle. The dispensing of fluid may continue as the pump 1000 continues to pump vapor into and pressurize the source container.

In some examples, the pump may be configured in a closed or sealed system comprising a receiving container, the pump and a fluid conduit (e.g., a two line hose), such that active pumping of vapor from the receiving container results in delivering of fluid (e.g., liquid) to the receiving container, as described below. In this example, activation of the pump would pump air and or vapor out of the receiving container to produce a negative pressure within the receiving container. This results in a suction being created in the passive liquid delivery passage that acts to draw fluid from a source (e.g., the source container) into the receiving container. Additionally, if the dual line fluid conduit connects the pump to the source container (e.g., via a coupler) in a closed or sealed arrangement, the air/vapor being pumped from the receiving container would pressurize the source container. The positive pressure created within the source container would additionally force the liquid in the source container through the passive liquid delivery passage of the pump into the receiving container. In this way, a liquid may be delivered to a receiving container by drawing the liquid into the receiving container with a negative pressure (e.g., negative vapor pressure) as well as pushing the liquid out of the source container into the receiving container with a positive pressure (e.g., positive vapor pressure).

An example operation of the pump 1000 for active pumping of liquid and passive recovery of vapor is now described. In this example, the pump 1000 may be allowed to run continuously. When the dispensing valve in the nozzle is closed, fluid pressure would build up in the fluid delivery passage causing the pressure-limiting valve 1040 to open, resulting in recirculation of liquid within the pump. When the dispensing valve in the nozzle is opened, the pressure in the fluid delivery passage would decrease allowing the pressure-limiting valve 1040 to close so liquid would then flow through the nozzle. In some examples, where vapor recovery is desired, the pump may be in a closed or sealed system comprising the source container, the pump, a dual line fluid conduit and a dual conduit nozzle. Once fluid is allowed to flow from the nozzle, pressure within the source container would decrease due to the liquid being dispensed out. This drop in pressure would cause fluid (e.g., vapor) to be drawn from the receiving container into the source container, to replace the liquid being pumped out.

The example pump 1000 may be useful in that the pump 1000 is able to provide both active fluid recovery and passive fluid delivery (or vice versa) within a single pump, and that both fluid recovery and fluid delivery passages 1010, 1015 are provided in the pump 1000 (even though only one of the passages is actively pumped). Such a configuration may be useful for a dispensing system that has active fluid recovery and passive fluid delivery (e.g., as shown in FIG. 2). The function of the fluid delivery and fluid recovery passages 1010, 1015 may also be switched such that the pump 1000 enables active fluid delivery and passive fluid recovery. A dual-line fluid conduit may be directly connected to the pump 1000 at the fluid delivery outlet 1035 and fluid recovery inlet 1020. The configuration of the fluid recovery and fluid delivery passages 1010, 1015 may substantially match the configuration of the two passages in the dual-line conduit (e.g., one passage within the other). In some examples, the configuration of the fluid delivery outlet 1035 and fluid recovery inlet 1020 may be different from the configuration of the fluid delivery inlet 1030 and fluid recovery outlet 1025. For example, the fluid delivery inlet 1030 and fluid recovery outlet 1025 may be separate and distinct from each other while the fluid delivery outlet 1035 and fluid recovery inlet 1020 may be integrated together or provided one within the other. A number of other variations may be appropriate.

In some examples, the pump 1000 may be provided with an electric motor 1005 for powering the pump 1000. There may also be a power receptacle (not shown) for receiving power to the motor from a power source. The motor and the power receptacle may both be integrated with the pump body 1060. The power receptacle may be configured to be used with the power connector of FIGS. 6-8, for example, to reduce the risk of a spark when coupling a power source to the pump 1000. In some examples, the pump 1000 may include a second pumping portion, which may also be powered by the motor. The second pumping portion may serve to pump fluid through the fluid delivery passage 1015, such that the pump 1000 actively pumps fluid through both fluid passages.

In some examples, the pump 1000 may include a pressure-actuated pump valve (not shown), such as the pump valve described in PCT application no. PCT/CA2012/000986. The pressure-actuated pump valve may operate similarly to the pressure-actuated dispensing valve described herein.

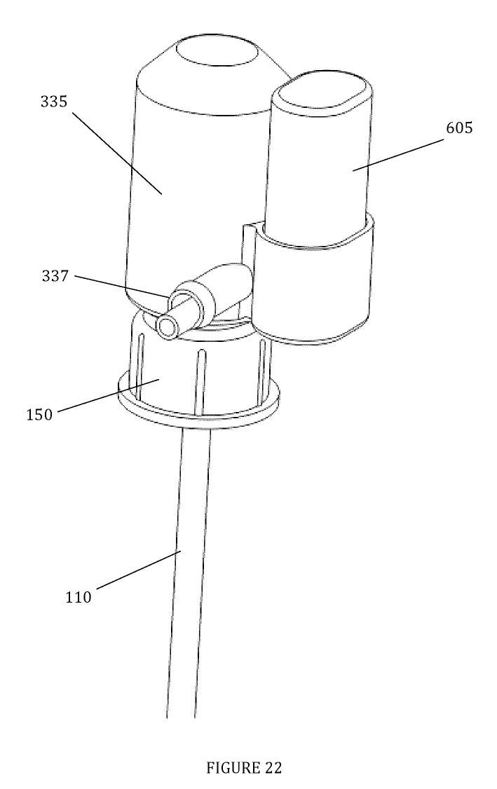

Reference is now made to FIGS. 22-24. These figures illustrate examples of the present disclosure that enable non-powered dispensing components and systems to be adapted to be a power-assisted dispensing system. The motor 335 (which may be integrated with a motorized pump) may be retrofitted on any existing non-powered dispensing system.

FIG. 22 illustrates an example of a motor 335 and pump that may be coupled to any suitable source container (e.g., a portable fuel container) via a suitable coupler 150. The motor 335, which may include a power source such as a battery pack 605, may be configured to enable coupling with the outlet of the source container using any coupler 150 that is configured for use with the source container. Any suitable fluid conduit 110 may enable fluid communication between the motorized pump and the source container (e.g., from the bottom of the interior of the source container). Thus coupled, the pump may be able to pump fluid to and/or from the source container, as described above. The coupler 150 may be any suitable coupler, including any coupler conventionally used for coupling the outlet of the source container to a single line hose or a dual line hose. Such a coupler may provide an air-tight leak-proof seal. Another fluid conduit (e.g., conduit 210, 310 described above) providing fluid communication with a nozzle of the conventional dispensing system may be attached to the pump outlet 337. In the example shown, the motorized pump is a dual pump with a liquid outlet and a fluid inlet for attaching to a dual line conduit. In other examples, the pump may be single line pump for attaching to a single line conduit, or the pump may be a dual pump with separate inlet and outlet for attaching to separate inlet and outlet conduits.

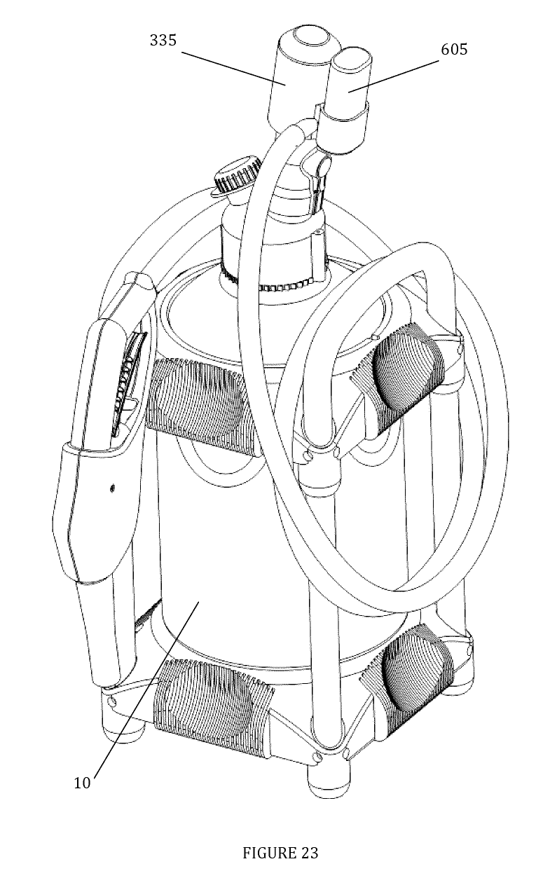

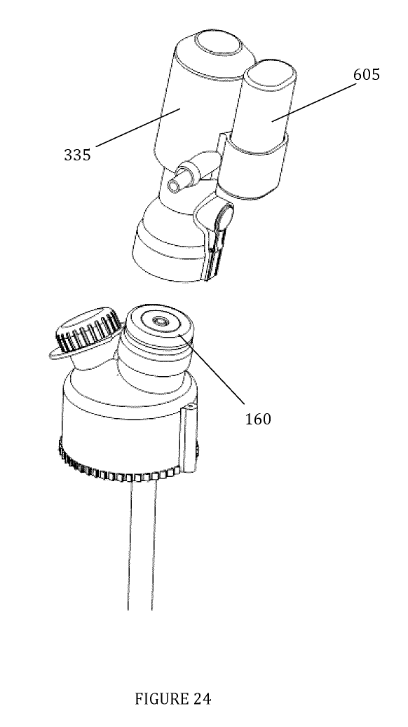

FIG. 23 illustrates an example of a power-assisted dispensing system being implemented on a source container 10, in this example a container as described in PCT application no. PCT/CA2012/000237. In this example, the motorized pump may be coupled to the source container 10 via a quick disconnect fitting (e.g., a dry break connector 160, as illustrated in FIG. 24), as described in the PCT application. Such a connector may enable the pump to be easily installed and removed, rather than requiring the pump to be manually screwed onto the source container 10. This may allow a user to either pump the liquid from the container using the powered pump, and to quickly switch the pump with a pouring spout (e.g., as described in PCT application no. PCT/CA2012/000237) if the user wishes to pour the liquid out of the container. This may be useful in situations where there is residual liquid in the source container 10 that cannot be pumped out by the pump (e.g., the residual liquid which cannot be pumped out by the pump and/or is at a level that is too low to be reached by the pump).

In other examples (not shown), a non-powered dispensing system may be retrofitted with a powered pump by coupling the pump between the nozzle and the conduit (e.g., as shown in FIG. 5), or elsewhere in the system.

Although the example shown illustrates the battery pack being provided on the pump, in other examples the battery pack may be provided remotely from the pump, as long as the battery pack is able to provide power to the pump. For example, the pump may be integrated into the nozzle while the battery pack is located remotely (e.g., on the source container or is a car battery), or the battery pack may be integrated into the nozzle while the pump is located remotely (e.g., on or in the source container).

Where the pump is located remotely from the source container, the pump may be plumbed to the source container with a conduit, such as a length of tubing or hose. Alternatively, the pump may be located on (e.g., exterior, interior, or partially in or through a wall of the source container) or integrated with the source container (e.g., any commercial, industrial or portable container), for direct access to the fluid contained within.

In some examples, where the motorized pump is provided on the body of a nozzle, safety mechanisms provided on the nozzle (e.g., trigger, safety hook, fluid sensor) may govern power to the motor. The nozzle may include any suitable dispensing valve (e.g., a standard valve, a dual valve, a pressure-actuated valve) and/or a fluid return apparatus.

Any combination of the safety features described herein (e.g., the trigger, safety hook, fluid sensor, orientation sensor, pressure valve, Venturi-based auto-shutoff mechanism) may be used to effect and/or control power to the motor, to avoid operating the pump when the dispensing system is not in a ready or safe configuration. The dispensing system may also include any combination of features (e.g., fluid return apparatus, pressure-actuated valves, pressure-limiting valve) that mechanically control fluid flow, such that fluid is not unintentionally dispensed. The dispensing system may use any combination of manual, electrical and mechanical safety features, as discussed herein.

The dispensing system may also include features described in previously filed PCT applications, such as described in PCT Application Nos. PCT/CA2012/000237, entitled “PORTABLE FLUID CONTAINER ASSEMBLY, FLUID CONNECTOR AND ATTACHMENT”, PCT/CA2005/001367 entitled “PUMP AND NOZZLE LIQUID FLOW CONTROL SYSTEM”, PCT/CA2007/000025 entitled “LIQUID DELIVERY SYSTEM FOR SUPPLYING LIQUID FROM A PORTABLE CONTAINER TO AT LEAST ONE SELECTED REMOTE DESTINATION AND REMOVING VAPOUR FROM THE AT LEAST ONE SELECTED REMOTE DESTINATION”, PCT/CA2007/002081 entitled “VAPOR-RECOVERY-ACTIVATED AUTO-SHUTOFF NOZZLE, MECHANISM AND SYSTEM”, PCT/CA2010/000116 entitled “A NOZZLE FOR USE IN A NON-OVERFLOW LIQUID DELIVERY SYSTEM”, PCT/CA2010/000115 entitled “AUTOMATIC SHUT-OFF NOZZLE FOR USE IN A NON-OVERFLOW LIQUID DELIVERY SYSTEM”, PCT/CA2012/000261 entitled “FLUID RECOVERY DISPENSER HAVING INDEPENDENTLY BIASED VALVES”, PCT/CA2012/000986 entitled “CONTAINER FOR PUMPING FLUID”, PCT/CA/2007/001274, entitled “PORTABLE PUMPING APPARATUS FOR CONCURRENTLY PUMPING LIQUID FROM A SOURCE CONTAINER TO A DESTINATION CONTAINER AND PUMPING VAPOR FROM THE DESTINATION CONTAINER TO THE SOURCE CONTAINER”, PCT/CA/2007/001291 entitled “PORTABLE FLUID EXCHANGE SYSTEM FOR CONCURRENTLY PUMPING LIQUID FROM A SOURCE CONTAINER TO A DESTINATION CONTAINER AND PUMPING VAPOR FROM THE DESTINATION CONTAINER TO THE SOURCE CONTAINER”, and PCT/CA2010/000112 entitled “A NON-OVERFLOW LIQUID DELIVERY SYSTEM”, for example.

Components and sub-systems of the dispensing system are also within the scope of the present disclosure. For example, the present disclosure may provide a pump system with a pump (which may be a motorized pump) that has one actively pumped fluid line and one passive fluid line. The pump system may include an electric motor with a receptacle for a power connector with a spark-preventing mechanism The pump may also include a pressure-limiting valve. A pressure-actuated pump valve may be provided, which may have high opening pressure (also referred to as cracking pressure) and lower pumping pressure.

The present disclosure may also provide a nozzle including an actuator (e.g., a trigger and/or safety hook) that enables operation of a pump (e.g., a motorized or manual pump) and/or the dispensing of fluid. The nozzle may be capable of fluid delivery and/or fluid recovery. The nozzle may include a pressure-actuated dual valve for controlling fluid flow in the fluid delivery and fluid recovery passages. The nozzle may also include a fluid return apparatus as disclosed herein.

In some examples, the present disclosure may provide a dispensing system that includes a portable source container, a motorized pump having a receptacle for a spark-preventing power connector and/or a pressure-actuated pump valve, a dual-line nozzle with a pressure-actuated dual valve and a fluid return apparatus, and a fluid conduit for fluid communication between the source container and the nozzle. The pump may be connected to the source container or the nozzle.

In some examples, various safety features discussed herein (e.g., the fluid return apparatus, pressure-actuated valves, pressure-limiting valve, safety hook, trigger) may be used in any suitable combination for a manually-operated system (e.g., with a manually operated pump). That is, the features disclosed herein may provide benefits that are not limited to use within a power-assisted dispensing system.

Although the present disclosure, in various examples, makes reference to fluid delivery and fluid recovery passages, it should be understood that the function of these passages may be reversed if appropriate. Generally, the fluid delivery and fluid recovery passages may function as fluid conduits (regardless of the direction of fluid flow), and may serve to conduct liquid, vapor and/or gas, as appropriate.

In various examples, the present disclosure may be useful for dispensing of liquid fuels (e.g., gasoline). The present disclosure may also be useful for dispensing other liquids, such as other chemicals, solvents, pesticides and fertilizers, among others.

The embodiments of the present disclosure described above are intended to be examples only. Alterations, modifications and variations to the disclosure may be made without departing from the intended scope of the present disclosure. In particular, selected features from one or more of the above-described embodiments may be combined to create alternative embodiments not explicitly described. All values and sub-ranges within disclosed ranges are also disclosed. The subject matter described herein intends to cover and embrace all suitable changes in technology. All references mentioned are hereby incorporated by reference in their entirety.

1-37. (canceled)

38. A fluid dispensing nozzle for use with a portable container, the fluid dispensing nozzle comprising:
a fluid delivery passage for delivering fluid out from a fluid delivery outlet;
a pump system comprising:
a first pumping portion for pumping fluid through a first fluid passage, the first fluid passage having a first fluid inlet and a first fluid outlet;
an electric motor for powering the first pumping portion to pump fluid through the first fluid passage; and
a power receptacle for receiving power to the electric motor;
a fluid conduit for fluid communication from the container interior to the nozzle;
wherein the pump system is coupled to one of the source container or the fluid dispensing nozzle; and
a power connector comprising:
a connector body for insertion into the power receptacle;
a first lead and a second lead housed in the connector body, and in electrical connection with a power source;
a first terminal and a second terminal accessible from an exterior of the connector body for providing power to the electric motor; and
a first retaining clip having a depressed configuration and a retaining configuration, the first retaining clip in the retaining configuration being configured to enable the power connector to be retained in the power receptacle;
wherein the first retaining clip is biased to the retaining configuration.

39. The fluid dispensing nozzle of claim 38, further comprising an actuator for controlling operation of the pump system.

40. The fluid dispensing nozzle of claim 38, wherein the nozzle further comprises a fluid delivery valve for controlling flow of fluid comprising:
a first valve portion configured to control fluid flow through the fluid delivery passage, the first valve portion being biased towards a first closed configuration in which fluid delivery out the fluid delivery outlet is inhibited;
the fluid delivery valve defining a first area, the first area being subjected to a force due to fluid pressures from any fluid in the fluid delivery passage, when the first valve portion is in the first closed configuration;
wherein the first valve portion is configured to be unseated from the first closed configuration by force due to fluid pressures exerted on the first area; and
wherein the fluid delivery valve further defines a second area larger than the first area, the second area being subjected to a force due to fluid pressures in the fluid delivery passage when the first valve portion has been unseated from the first closed configuration, wherein the first valve portion is configured to be maintained away from the first closed configuration by force due to fluid pressures exerted on the second area, and wherein fluid pressure required to unseat the first valve portion from the first closed configuration is greater than fluid pressure required to maintain the first valve portion away from the first closed configuration

41. The fluid dispensing nozzle of claim 38, wherein the nozzle further comprises a fluid recovery passage for recovering fluid in from a fluid recovery inlet;
wherein the nozzle further comprises a dual valve for controlling flow of fluid comprising:
a first valve portion configured to control fluid flow through the fluid delivery passage, the first valve portion being biased towards a first closed configuration in which fluid delivery out the fluid delivery outlet is inhibited;
a second valve portion configured to control fluid flow through the fluid recovery passage, the second valve portion being biased towards a second closed configuration in which fluid recovery into the fluid recovery inlet is inhibited;
the valve defining a first area, the first area being subjected to a force due to fluid pressures from any fluid in the fluid delivery passage, when the first valve portion is in the first closed configuration;
wherein the first valve portion is configured to be unseated from the first closed configuration by force due to fluid pressures exerted on the first area; and
wherein unseating of the first valve portion away from the first closed configuration results in unseating of the second valve portion away from the second closed configuration.

42. The fluid dispensing nozzle of claim 41, wherein dual valve of the nozzle further defines a second area larger than the first area, the second area being subjected to a force due to fluid pressures in the fluid delivery passage when the first valve portion has been unseated from the first closed configuration, wherein the first valve portion is configured to be maintained away from the first closed configuration by the force due to fluid pressures exerted on the second area, and wherein fluid pressure required to unseat the first valve portion from the first closed configuration is greater than fluid pressure required to maintain the first valve portion away from the first closed configuration

43. The fluid dispensing nozzle of claim 38, wherein the nozzle further comprises a fluid recovery passage for recovering fluid in from a fluid recovery inlet;
wherein the nozzle further comprises a fluid return apparatus comprising:
a through-passage permitting fluid communication between the fluid delivery passage and the fluid recovery passage; and
a fluid return valve for controlling flow of fluid between the fluid delivery passage and the fluid recovery passage, the fluid return valve having:
a first configuration in which fluid communication between the fluid delivery passage and the fluid recovery passage via the through-passage is inhibited; and
a second configuration in which fluid communication between the fluid delivery passage and the fluid recovery passage is permitted via the through-passage.

44. The fluid dispensing nozzle of claim 38, wherein the nozzle further comprises a fluid recovery passage for recovering fluid in from a fluid recovery inlet, and the nozzle further comprises a second fluid conduit for fluid communication from the nozzle to the container interior.

45. The fluid dispensing nozzle of claim 38, wherein the pump system further comprises a second fluid passage having a second fluid inlet and a second fluid outlet, fluid in the second fluid passage not being pumped by the first pumping portion.

46. The fluid dispensing nozzle of claim 45, wherein the pump system further comprises a second pumping portion for pumping fluid through the second fluid passage, wherein the second pumping portion is operatively connected to the electric motor for powering the second pumping portion to pump fluid through the second fluid passage

46. The fluid dispensing nozzle of claim 38, wherein when the first retaining clip of the power connector is in the retaining configuration, at least one of the first or second terminal is caused to come into electrical connection with the respective first or second lead and wherein when the first retaining clip is in the depressed configuration, at least one of the first or second terminal is prevented from being in electrical contact with the respective first or second lead

47. The fluid dispensing nozzle of claim 46, wherein the power connector further comprises:
a second retaining clip having a depressed configuration and a retaining configuration;
wherein the second retaining clip is biased to the retaining configuration, the second retaining clip, in the retaining configuration, causing the other of the first or second terminal to come into electrical connection with the respective first or second lead; and
wherein when the second retaining clip is in the depressed configuration, the other of the first or second terminal is prevented from being in electrical contact with the respective first or second lead.

48. The fluid dispensing nozzle of claim 38, wherein the power connector further comprises the power source, wherein the power source includes a battery material housed in the connector body, and wherein the first and second leads are in electrical contact with the battery material.

49. The fluid dispensing nozzle of claim 38, wherein the first and second leads of the power connector form electrical connections with a power cord, for connecting to the power source.

50. The fluid dispensing nozzle of claim 38, further comprising a portable source container having at least a container fluid outlet.
